(19) United States
(12) Patent Application Publication
(10) Pub. No.: US 2025/0374235 A1
(43) Pub. Date: Dec. 4, 2025

(54) CONFIGURATION FOR RADIO SENSING

(71) Applicant: Lenovo (Singapore) Pte. Limited, Singapore (SG)

(72) Inventors: Seyedomid Taghizadeh Motlagh, Oberursel (DE); Ali Ramadan Ali, Kraiburg (DE); Vijay Nangia, Woodridge, IL (US)

(73) Assignee: Lenovo (Singapore) Pte. Limited, Singapore (SG)

(21) Appl. No.: 19/107,832

(22) PCT Filed: Aug. 28, 2023
(86) PCT No.: PCT/IB2023/058499

§ 371 Date: Feb. 28, 2025

Related U.S. Application Data
(60) Provisional application No. 63/402,306, filed on Aug. 30, 2022.

(51) Int. Cl. H04W 64/00; H04B 7/06; H04L 5/00; H04W 24/10

(52) U.S. Cl. CPC H04W 64/006; H04B 7/0626; H04L 5/0051; H04W 24/10

(57) ABSTRACT

Various aspects of the present disclosure relate to methods, apparatuses, and systems that support configuration for radio sensing. For instance, implementations provide for configuration of sensing-related nodes with knowledge of background environments related to specific radio sensing scenarios to assist in sensing receiver processing. Further, knowledge of features of a background environment can be used as assistance information for extracting sensing information for target objects, such as based on information pertaining to signal interactions between a background environment and target objects.

### RELATED APPLICATION

This application claims priority to U.S. Provisional Application Ser. No. 63/402,306 filed 30 Aug. 2022 entitled “CONFIGURATION FOR RADIO SENSING,” the disclosure of which is incorporated by reference herein in its entirety.

### TECHNICAL FIELD

The present disclosure relates to wireless communications, and more specifically to radio sensing.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless system designs specify the use of radio sensing for detecting environmental attributes. Radio sensing, for example, uses radio signals and/or devices to attempt to detect attributes of an ambient environment.

### SUMMARY

The present disclosure relates to methods, apparatuses, and systems that support configuration for radio sensing. For instance, implementations provide for configuration of sensing-related nodes with knowledge of a background environment related to specific radio sensing scenarios to assist in sensing receiver processing. Knowledge of features of a background environment, for example, assists in mitigating the impact of clutter reflections on detection of a target object. Further, knowledge of features of a background environment can be used as assistance information for extracting sensing information for target objects, such as based on information pertaining to signal interactions (e.g., signal reflection, signal blockage, etc.) between a background environment and target objects.

Accordingly, the described techniques provide increased precision for radio sensing of target objects in different environments and can reduce power consumption by providing radio sensing and background environment information for use in processing radio sensing data.

Some implementations of the methods and apparatuses described herein may further include receiving a first indication including reference signal configuration, a second indication including acquisition information for background environment attributes, and a third indication including measurement configuration for radio sensing measurement; and performing, based on the received first, second and third indications, one or more of: receiving one or more reference signals; obtaining background environment attributes based at least in part on the one or more reference signals and the second indication; or generating one or more radio sensing measurements based at least in part on one or more of the reference signal configuration from the first indication, the obtained background environment attributes, the second indication, or the measurement configuration from the third indication.

Some implementations of the methods and apparatuses described herein may further include: where the measurement configuration includes information for generating the one or more radio sensing measurements based at least in part on the background environment attributes; receiving the one or more reference signals based on the first indication from at least one of: an apparatus that transmits one or more of the first indication, the second indication, or the third indication; or a different apparatus than an apparatus that transmits one or more of the first indication, the second indication, or the third indication; where the reference signal configuration includes at least one of: one or more of a waveform type or a set of waveform-defining parameters according to a waveform via which the one or more reference signals are transmitted; a set of resources over which the one or more reference signals are transmitted according to the waveform; one or more of a transmit beam or a radiation pattern over which the one or more reference signals are transmitted; a transmit power according to which the one or more reference signals are transmitted; one or more of a sequence type or a physical-resource-mapping type based on which the one or more reference signals are generated; or a location of a transmit node from which the one or more reference signals are transmitted.

Some implementations of the methods and apparatuses described herein may further include: where the set of resources over which the one or more reference signals are transmitted include one or more time-frequency resources for a cyclic-prefix orthogonal frequency-division multiplexing (CP-OFDM) waveform; where the acquisition information for background environment attributes includes at least one of: a resource set including at least one of a set of time resources, a set of frequency resources, or a set of beam resources for reception of the background environment attributes; or one or more types of the background environment attributes embedded within the said resource set, where the one or more types of the background environment attributes include at least one of one or more data types or one or more format types; where the one or more types of the background environment attributes include at least one of: one or more of an object identifier or a group object identifier; one or more object features including at least one of an object position, an object velocity, an object radar cross section pattern, an object shape, an object type, an object orientation, an object composite, or an object texture; a map of a background environment; one or more channel state information (CSI) measurements including at least a portion of a background environment effect and an indication of a CSI measurement type; one or more of compressed values or quantized values for the background environment attributes; or one or more statistical measures of background environment attributes.

Some implementations of the methods and apparatuses described herein may further include: where the acquisition information for background environment attributes includes at least one of: one or more second configurations defining one or more reference signals other than the received one or more reference signals received from a second apparatus according to the reference signal configuration of the first indication; one or more third configurations defining one or more reference signals received from a third apparatus; or a subset of time-frequency resources defined within the reference signal configuration received with the first indication; where the one or more second configurations and the one or more third configurations include one or more of a set of time resources, a set of frequency resources, a set of beam resources, a transmit beam, a radiation pattern, a waveform, a transmit location, or a transmit power; where the acquisition information for background environment attributes includes state information including at least one of: an indication of one or more states of one or more objects within the background environment; or an indication of one or more states of one or more target objects.

Some implementations of the methods and apparatuses described herein may further include: where the acquisition information for background environment attributes includes one or more of: indication of one or more reference signal receptions for which the state information is valid; or a time pattern for which the state information is valid; receiving the state information subsequent to the one or more reference signals; receiving a fourth indication including: an instruction to perform one or more of quantization or compression on at least one of the one or more reference signals or the one or more radio sensing measurements to generate one or more of quantized values or compressed values; and an instruction to store one or more of the quantized values, the compressed values, or the one or more radio sensing measurements, and the time pattern for which the state information is valid; further including receiving the state information prior to the one or more reference signals.

Some implementations of the methods and apparatuses described herein may further include: where the first indication including reference signal configuration includes an excitation relationship for radio sensing with respect to a known reference signal configuration; where the excitation relationship for radio sensing is based on at least one of: illumination of an area of interest; an azimuth angle of an incident wave towards one or more of an area or object of interest for sensing; an elevation angle of an incident wave towards one or more of an area or object of interest for sensing; a portion of one or more of radiation or beam energy incited to one or more of an area or object of interest for sensing; a portion of one or more of radiation or beam energy incited to a background environment for a sensing scenario; a portion of one or more of an area or object of interest for sensing which is illuminated by the one or more reference signals; or a portion of a background environment of interest for sensing which is illuminated by the one or more reference signals.

Some implementations of the methods and apparatuses described herein may further include: where the third indication including measurement configuration for radio sensing measurement includes at least one of: an indication of one or more spatial filters to be used for reception of the one or more reference signals; one or more sensing information outcomes to be generated from the radio sensing measurements and the background environment attributes; one or more of sensing quality of service or key performance indicators to be considered for information output of the one or more radio sensing measurements; one or more conditions according to which a first radio sensing measurement is to be performed when a second radio sensing measurement result occurs; or one or more conditions on a quality of an information output of a first radio sensing measurement when a second radio sensing measurement result occurs; where the at least some types of the information output include at least one of: one or more of quantized or compressed received one or more reference signals; one or more channel state information (CSI) measurements obtained from the one or more received reference signals; one or more of deterministic or statistical inference of a presence of an object of interest; one or more of deterministic or statistical knowledge of a location of an object of interest; one or more of deterministic or statistical knowledge of a velocity of an object of interest; one or more of deterministic or statistical knowledge of a radar cross section (RCS) of an object of interest; or one or more of deterministic or statistical knowledge of at least one of a type, shape, composite, or posture of an object of interest.

Some implementations of the methods and apparatuses described herein may further include: where the measurement configuration for radio sensing measurement is based at least in part on: an indication of a first CSI measurement for a first reference signal relative to one or multiple of: a second CSI measurement for a second reference signal; or one or more indicated CSI measurement values; where the indication of the first CSI measurement relative to the second CSI measurement includes one or more of: a first CSI measurement type; an operation type; or an operation stage; where the CSI measurement type includes measurements relative to at least one of: delay domain; angular-azimuth domain; one or more of angular-elevation or zenith domain; doppler domain; power domain; rank measurement; quantized values of CSI measurements; compressed values of CSI measurements; or summation of CSI measurements; where the operation stage includes at least one of: a signal reception stage; a CSI measurement type similar to the first CSI measurement type; or a second CSI measurement type different than the first CSI measurement type; where the operation type includes at least one of: subtraction of CSI measurement values; filtering out of the first CSI measurement according to a non-zero presence of the second CSI measurement; division of the first CSI measurement and the second CSI measurement; summation of the first CSI measurement and the second CSI measurement; one or more of stacking or aggregation of the first CSI measurement and the second CSI measurement; or one or more of joint quantization or compression of the first CSI measurement and the second CSI measurement.

Some implementations of the methods and apparatuses described herein may further include: receiving a fourth indication including a configuration for transmitting a sensing measurement report based at least in part on the one or more radio sensing measurements; and transmitting the sensing measurement report based at least in part on the fourth indication; where the fourth indication includes at least one of: a set of time, frequency, and beam resources for transmission of the sensing measurement report; a criterion for the transmission of the sensing measurement report; or type of information to include in the sensing measurement report; where the third indication including measurement configuration for radio sensing measurement includes one or more sensing information outcomes to be generated from the radio sensing measurements and the background environment attributes, and where the one or more sensing information outcomes include a modification of a feature of one or more of an object of interest or a background environmental element.

Some implementations of the methods and apparatuses described herein may further include: receiving one or more indications including one or more of: a first indication including reference signal configuration; a second indication including acquisition information for background environment attributes; a third indication including measurement configuration for radio sensing measurement; a fourth indication including configuration for reception of a sensing measurement report; a fifth indication including configuration for processing of obtained sensing measurements; or a sixth indication including a configuration for generating and transmitting a report; and performing, based on the one or more received indications, one or more of: receiving one or more radio sensing measurements; obtaining background environment attributes based on at least in part on one or more of the received sensing measurements or the received second indication; performing processing on the received radio sensing measurement based at least in part on one or more of the received sensing measurements, the received fifth indication, or obtained background attributes; or generating and transmit a report, where the report is generated at least in part based on the performed processing of the received sensing measurements and is transmitted based on at least partially on the received sixth indication.

Some implementations of the methods and apparatuses described herein may further include: transmitting, from a first apparatus to a second apparatus, a first indication including reference signal configuration; transmitting, to the second apparatus, a second indication including acquisition information for background environment attributes; and transmitting, to the second apparatus, a third indication including measurement configuration for radio sensing measurement; receiving, from the second apparatus, a measurement report including radio sensing measurements configured based at least in part on one or more of the reference signal configuration, the acquisition information for background environment attributes, or the measurement configuration for radio sensing measurement.

### BRIEF DESCRIPTION OF THE DRAWINGS

FIG. 1 illustrates an example of a wireless communications system that supports configuration for radio sensing in accordance with aspects of the present disclosure.

FIG. 2 illustrates an example scenario for radio sensing.

FIG. 3 illustrates example scenarios for radio sensing that support configuration for radio sensing in accordance with aspects of the present disclosure.

FIG. 4 illustrates example scenarios for radio sensing that support configuration for radio sensing in accordance with aspects of the present disclosure.

FIG. 5 illustrates a system for radio sensing that supports configuration for radio sensing in accordance with aspects of the present disclosure.

FIG. 6 illustrates a system for radio sensing that supports configuration for radio sensing in accordance with aspects of the present disclosure.

FIGS. 7 and 8 illustrate example block diagrams of devices that support configuration for radio sensing in accordance with aspects of the present disclosure.

FIGS. 9 through 12 illustrate flowcharts of methods that support configuration for radio sensing in accordance with aspects of the present disclosure.

### DETAILED DESCRIPTION

In some wireless communications system designs, radio sensing in wireless cellular wireless networks is envisioned both as a mechanism to improve network performance as well as to serve vertical use-cases. Radio sensing, for example, uses radio signals and/or devices to attempt to detect attributes of an ambient environment. As part of radio sensing, radio signals that are propagated and/or reflected are to be received and processed to determine environmental attributes such as objects present in an environment. Some current designs for radio sensing, however, do not provide for utilization of radio sensing intelligence for processing radio sensing data and thus may experience inaccuracies and/or processing latency when attempting to interpret radio sensing data.

Accordingly, the present disclosure relates to methods, apparatuses, and systems that support that support configuration for radio sensing. For instance, implementations provide for configuration of sensing-related nodes with knowledge of a background environment related to specific radio sensing scenarios to assist in sensing receiver processing. Knowledge of features of a background environment, for example, assists in mitigating the impact of clutter reflections on detection of a target object. A target object, for example, represents a specific object and/or object group (e.g., a person, a vehicle, etc.) and/or an area of interest that is designated for sensing. Further, knowledge of features of a background environment can be used as assistance information for extracting sensing information for target objects, such as based on information pertaining to signal interactions (e.g., signal reflection, signal blockage, etc.) between a background environment and target objects.

Throughout this disclosure a number of different devices and/or entities are discussed, including a device that transmits a sensing excitation signal (e.g., a sensing reference signal), which can be referred to herein as a sensing Tx node. Further, devices are discussed that receive transmitted sensing excitation signal (e.g., reference signal as affected by a background environment (e.g., the sensing reference signal is reflected, echoed, blocked, refracted, diffracted by the environment, etc.)), which may be referred to herein as a sensing Rx node.

Accordingly, this disclosure addresses issues pertaining to how knowledge of background environments for a specific sensing scenarios can be obtained by a sensing Rx node, how such information can be used to generate related sensing information, and how sensing information obtained with the assistance of the background information can be reported by a sensing Rx node.

For instance, the described implementations provide for:
explicit transfer of background environment information from a network and/or an aware entity to a sensing Rx node;
configuration of a sensing Rx node with a plurality of sensing reference signal receptions, including information elements defining a relationship of the different sensing reference signal receptions, where the environment knowledge can be extracted from the observation of the plurality of the sensing reference signal receptions;
configuration for a sensing Rx node to report the observed modifications of the background environment, including blockage events pertaining to background environment reflections;
excitation relationships for sensing such as to relatively define reference signal transmission characteristics for a sensing scenario with respect to a known and/or previously experienced beam; and
relative CSI measurements, including indication of an operation type, operation stage, and indication of a permissibility condition.

Accordingly, the implementations described in this disclosure provide a number of improvements and advantages, including improving radio sensing accuracy for sensing target objects as well as reduction of power usage by radio sensing nodes.

Aspects of the present disclosure are described in the context of a wireless communications system. Aspects of the present disclosure are further illustrated and described with reference to device diagrams and flowcharts.

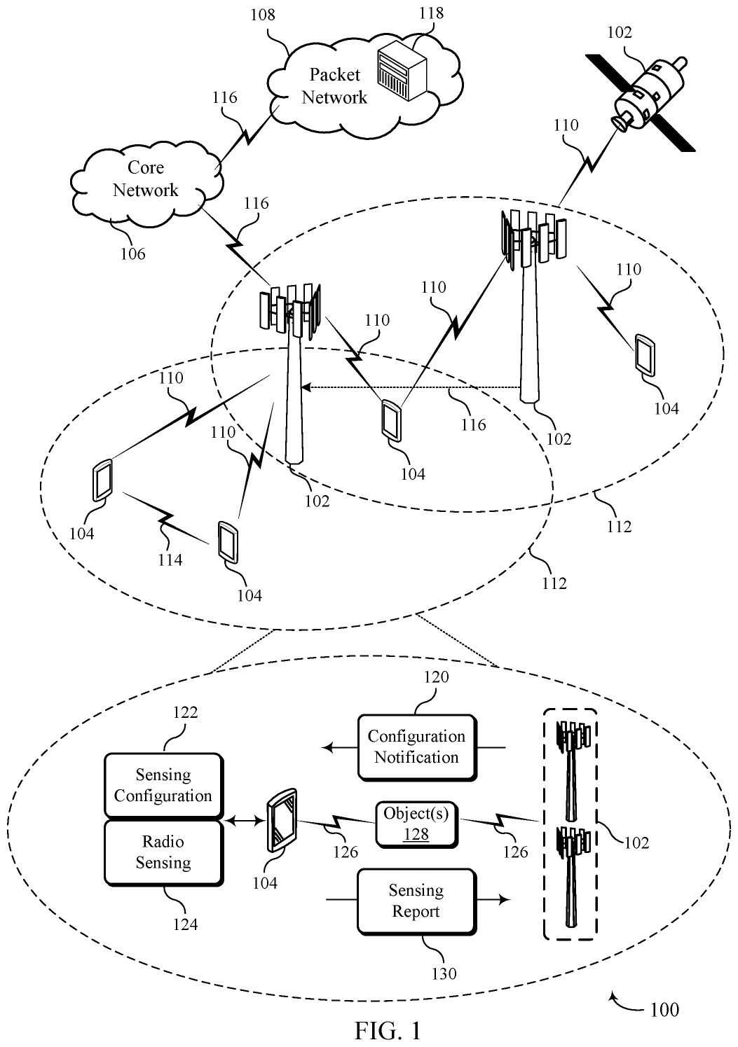

FIG. 1 illustrates an example of a wireless communications system 100 that supports configuration for radio sensing in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, media access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kilohertz (kHz)) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FRI may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for configuration for radio sensing, network entities 102 and a UE 104 can cooperate to enable radio sensing according to the described implementations. For instance, the network entities 102 represent one or more of a configuration node, a processor node, a sensing transmit node (“sensing Tx node”), and combinations thereof. Further, the UE 104 represents a sensing receiver node (“sensing Rx node”). This is not to be construed as limiting, however, and a variety of different node types and node implementations may be utilized as part of the disclosed implementations, such as further described below.

Further to the described example, a network entity 102 generates a configuration notification 120 and transmits the configuration notification 120 to a UE 104. The configuration notification 120, for instance, includes various radio sensing-related configuration information such as reference signal configuration, acquisition information for background environment attributes, measurement configuration for radio sensing measurement, known attributes of objects and/or scenarios of interest, processing configuration information for use in processing radio sensing measurements, reporting configuration for reporting radio sensing measurements, and so forth. In at least one implementation the configuration notification 120 references configuration information using indices to a codebook that includes fields that describe different objects and/or scenarios of interest. Detailed examples of different instances and/or types of radio sensing-related information that can be included in the configuration notification 120 are discussed throughout this disclosure.

The UE 104 receives the configuration notification 120 and implements (e.g., executes) sensing configuration 122 to configure different radio sensing-related logic and behaviors of the UE 104 based at least in part on the configuration notification 120. The sensing configuration 122, for instance, configures sensing, processing, and/or reporting logic and/or behaviors of the UE 104 and based at least in part on the configuration notification 120. Based on the sensing configuration 122, the UE 104 executes radio sensing 124. The radio sensing 124, for example, is based on reference signals 126 that are transmitted by a network entity 102 and received by the UE 104. The radio sensing 124 can be utilized to detect target objects 128 (e.g., objects of interest) that affect propagation of the reference signals 126, such as via signal interference, signal reflection, etc., caused by the target objects 128. As further detailed below, the radio sensing 124 can utilize known background environment attributes included as part of the sensing configuration 122 to identify and/or confirm identity of the target objects 128.

Based at least in part on the radio sensing 124 and/or processing of sensing measurements obtained by the radio sensing 124, the UE 104 generates a sensing report 130 and transmits the sensing report 130 to a network entity 102. The sensing report 130 can include various types of information such as sensing measurements generated by the radio sensing 124, processed sensing measurements, attributes of target objects 128 detected via the radio sensing 124, sensing configuration 122 information used by the UE 104 to generate and/or process sensing measurements, and so forth. In at least one implementation the sensing report 130 is generated and/or transmitted according to reporting configuration information included as part of the configuration notification 120 and/or the sensing configuration 122. The network entity 102, for instance, specifies reporting configuration information in the configuration notification 120 to be used by the UE 104 to generate the sensing report 130.

In some wireless communications system designs, radio sensing in wireless cellular wireless networks is envisioned both as a mechanism to improve network performance, as well as to serve vertical use-cases. In particular, radio sensing can obtain environment information by the means of:
transmission of a sensing excitation signal, e.g., a sensing reference signal (reference signal), from a network or UE entity, e.g., sensing Tx node;
reception of the reflections/echoes of the transmitted sensing excitation signal from an environment by a network and/or a UE entity, e.g., sensing Rx node; and
processing of the received reflections and inferring relevant information from the environment.

As indicated above, the propagated/reflected radio signals can be received and processed to extract environmental features and information of interest. Accordingly, it can be desirable to tailor signal reception, measurement, processing, and reporting processes to the nature of specified radio sensing tasks and information and the specified quality of service. An example list of the potential use-cases for such task-specific radio sensing measurements and reporting include, but not limited to:
Measurement of the radio propagations for detection of an object of interest, where the object, if present, is located in a known three dimensional (3d), or two dimensional (2d), and/or 1 dimensional (1d) area. Examples of different objects of interest include a pedestrian crossing a known road section, a train passing by the known route, a vehicle (e.g., driven by a human driver and/or autonomous vehicle) moving down a known road section, etc.
Measurement of the radio propagations for detection of an object of interest, such as where the object, if present, follows a specific velocity pattern. For instance, for an object of interest, the direction of travel is known and/or the absolute velocity is within an a priori known range and leads to a CSI component within an a priori known region in the doppler domain, e.g., a pedestrian with no more than 30 km/hour speed, a natural obstacle with zero speed, etc.

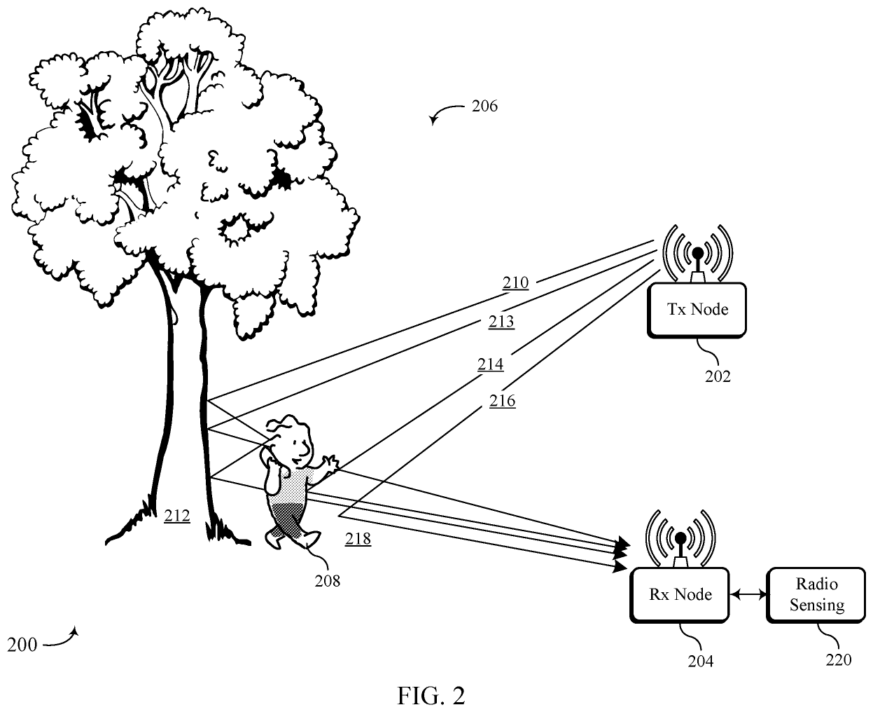

FIG. 2 illustrates an example scenario 200 for radio sensing. The scenario 200 includes a Tx node 202 and an Rx node 204. The Tx node 202 and the Rx node 204 can be implemented in various ways, such as a network entity 102, a UE 104, combinations thereof, etc. In the scenario 200 the Tx node 202 transmits reference signals within a background environment 206 that are affected by various background features and objects within the background environment 206. The scenario 200, for example, represents an implementation for tracking a pedestrian 208 within the background environment 206 based on an impact of the background environment 206 on the reference signals transmitted by the Tx node 202.

Further to the scenario 200 a reference signal 210 transmitted by the Tx node 202 is reflected off a background object 212 (e.g., a tree) and the pedestrian 208 before it arrives at the Rx node 204. Further, a reference signal 213 transmitted by the Tx node 202 is reflected off of the background object 212 before it arrives at the Rx node 204. A reference signal 214 transmitted by the Tx node 202 is reflected (e.g., directly) off of the pedestrian 208 before it arrives at the Rx node 204. Further, a reference signal 216 transmitted by the Tx node 202 is reflected (e.g., directly) off of a ground surface 218 of the environment 206 before it arrives at the Rx node 204. Accordingly, based on the different reference signals, the Rx node 204 can perform radio sensing 220 to measure attributes of reference signals received at the Rx node 204 and determine attributes of the pedestrian 208, e.g., a target object.

Thus, the impact of the background environment 206 on the transmitted reference signal can be observed. Such reflections are mixed with the reflections from a desired sensing target (e.g., the pedestrian 208) and if not subtracted, may degrade a resulting sensing information and/or accuracy. Further the reflections from the background environment 206 may be blocked due to the presence of an object of interest for sensing, which can be used as a useful additional information for a sensing task of interest.

Accordingly, the perceived signal at the Rx node 204 may include the following example effects: First, the reflection from an object and/or objects of interest to be sensed via radio sensing may be received; second, the reflection and direct propagation paths from the rest of the background environment 206 (e.g., the background environment) other than the object and/or objects of interest targeted for sensing (e.g., the pedestrian 208) which are combined with the reflections from the object of interest for sensing; third, the interactions of the background environment 206 with the reflections from the object and/or objects of interest, e.g., when a direct or reflective path from the background environment is blocked towards the Rx node 204 due to the presence of an object of interest, or when the object reflection is blocked due to another background environment element.

Example features for defining UE capabilities for sensing, where the UE acts as a sensing Tx for a sensing task associated with a sensing reference signal can be defined via a set of supported sensing reference signal patterns, including (but not limited to):
A supported time-domain resource pattern for sensing reference signal, e.g., a maximum supported length of the sensing reference signal in time domain, maximum number of symbols or symbol density for sensing reference signal transmission, maximum supported power/energy for sensing reference signal transmission, etc.
A supported frequency-domain resource pattern for sensing reference signal, e.g., a maximum supported bandwidth of the sensing reference signal in a frequency domain, maximum number of resource elements (REs) or RE density for sensing reference signal transmission, maximum supported power/energy for sensing reference signal transmission within a symbol, slot, and/or a radio frame, etc.
A supported joint time-frequency domain resource pattern for sensing reference signal, e.g., a maximum supported number of total REs per radio frame for sensing reference signal transmission, maximum supported power and/or energy for sensing reference signal transmission within a symbol, slot, and/or a radio frame, the supported frequency hopping patterns, etc.
Supported spatial filters, beams, and/or maximum supported number of simultaneously used spatial beams for sensing reference signal transmission.
Supported guard interval or cyclic prefix (CP) overhead for sensing symbols within sensing reference signal transmission.
Supported computation and/or determination for choosing the sensing reference signal resource pattern among a set of possible patterns for sensing reference signal transmission.
Supported computation and/or determination methods for choosing the sensing reference signal sequence among a set of possible sequences for sensing reference signal transmission.
Supported sequence generation strategies and/or the supported sets of sequence-generation defining parameters for sensing reference signal transmission.
Supported sequence-to-resources mapping-defining parameter set for sensing reference signal pattern generation for transmission.

Example features for defining UE capabilities for sensing, where the UE acts as a sensing Rx for a sensing task associated with a sensing reference signal can be defined via a set of supported sensing reference signal patterns, including (but not limited to):
Supported time-domain resource pattern for sensing reference signal reception, e.g., a maximum supported length of the sensing reference signal in time domain, maximum number of symbols or symbol density for sensing reference signal reception, etc.
A supported frequency-domain resource pattern for sensing reference signal reception, e.g., a maximum supported bandwidth of the sensing reference signal in frequency domain, maximum number of REs or RE density for sensing reference signal reception, etc.
A supported joint time-frequency domain resource pattern for sensing reference signal reception, e.g., the maximum number of total REs per radio frame for sensing reference signal reception, the supported frequency hopping patterns for sensing reference signal reception, etc.
Supported spatial filters, beams, and/or maximum number of simultaneously used spatial beams for sensing reference signal reception.
Supported guard interval and/or CP overhead for sensing symbols within sensing reference signal reception.
Supported detection and/or determination for an unknown (e.g., partially unknown) received sensing reference signal resource pattern among a set of possible patterns for sensing reference signal reception.
Supported detection and/or determination for an unknown (e.g., partially unknown) received sensing reference signal sequence among a set of possible sequences.
Supported sequence generation strategies for sensing reference signal transmission.
Supported sequence-to-resources mapping-defining parameter set for sensing reference signal reception.

Example features for defining UE capabilities for sensing, where the UE acts jointly as a sensing Rx and sensing Tx (e.g., in a full-duplex with simultaneous transmission and reception) for a sensing task associated with a sensing reference signal can be defined via a set of the supported sensing reference signal patterns, including (but not limited to):
Supported time-domain resource pattern for sensing reference signal joint transmission and reception.
Supported frequency-domain resource pattern for sensing reference signal joint transmission and reception.
Supported joint time/frequency-domain resource pattern including supported frequency hopping patterns for sensing reference signal joint transmission and reception.
Supported transmit and receive beam combinations for sensing reference signal joint transmission and reception.
Supported transmit power, e.g., average transmit power during sensing, maximum average transmit power during sensing in any of the slots, maximum transmit power during any transmit symbol, total sensing reference signal energy, for sensing reference signal joint transmission and reception.
Features for supported transmit power for sensing which are defined specific to a transmit beam or Tx/Rx beam combination supported for joint sensing reference signal transmission and reception.
Features defining allowed combinations of the supported set of sensing reference signal for transmission and the supported set of sensing reference signal for reception.

Example features for defining UE capabilities for sensing reference signal multiplexing can include (but are not limited to):
Number of sensing reference signal that can be multiplexed within a same radio frame and/or exist at the same time, e.g., exist when other ones are started and before the other ones are ended.
Type of data and/or control channels or other RSs that can coexist with a sensing reference signal, e.g., exist after the channel and/or reference signal starts and before the channel and/or reference signal ends.
Support of discrete Fourier transform (DFT) spreading on the sensing reference signal and/or a multiplexed sensing reference signal.
For all the above, a supported type of multiplexing.

Example features for defining UE capabilities for sensing measurements, where the UE operates as sensing Rx can be defined via a set of supported measurement types, including (but not limited to):
Supported methods and/or computational models for sensing measurement, e.g., time-domain processing for time-of-flight estimation, CP-OFDM-based doppler and/or range estimation, available computational and/or artificial intelligence (AI) models for sensing measurements).
Support for distance and/or range estimation, supported dynamic range of the object distance for estimation, supported distance estimation resolution.
Support for object speed estimation, supported dynamic range of the object speed for estimation, supported speed estimation resolution.
Support for angular estimation (e.g., direction of arrival (DoA) estimation), supported dynamic range of DoA for estimation, supported DoA estimation resolution.
Maximum number of simultaneously supported objects for sensing measurements.
Support for measurement features defined as a combination of any of the above features, e.g., support of DoA estimation for the objects with a specific distance dynamic range and a specific distance resolution.

Example features for defining UE capabilities for sensing measurements reporting, where the UE operates as sensing Rx can be defined via a set of supported measurement reporting types, including (but not limited to):
Types of the supported message and/or reporting, e.g., compression of the measurements, estimated parameters, event-based reporting with a defined criterion, etc.
Duration that a measurement message can be stored by the UE before transmission and/or reporting.
Supported reporting criterion, e.g., comparison of an estimated distance with a threshold, and/or computational models for checking a reporting criteria.
Supported compression types for a reporting message.

For particular radio sensing tasks, information elements that specify sensing QoS and/or sensing information type include (but are not limited to):
Sensing information type: in some implementations, a type of information to be obtained via a sensing procedure can be included in a request message. This includes, e.g., indication of a request for object and/or blockage detection, material and/or composite estimation, tracking and/or ranging of an object of interest, estimating the speed of an object of interest, etc. In some implementations, requested information can be defined explicitly to facilitate scheduling and/or a proper response determination by the network.
QoS for sensing information: In some implementations, QoS parameters for the requested sensing information is included in a request message, e.g., by a UE. Examples of this sensing QoS information include (but are not limited to):
   Latency: the tolerable latency requirement for the accomplishment of the requested sensing operation. The measurable time duration may be defined as the time-difference from the transmission of the request or reception of the request by the network to one or more of: the reception of the response from the network, reception of a sensing reference signal transmitted in response to the UE request, accomplishment of the sensing procedure, or reception and/or recovery of the intended sensing information by the UE, etc.
   Reliability/Accuracy: information on the accuracy of the obtained sensing information can be defined, such as via one or more of: tolerable probability of false alarm for detection within an object and/or area of interest, specified probability of detection for detection within an object and/or area of interest, tolerable error measure for parameter estimation, e.g., estimation of speed or distance of an object of interest.
   Request importance: In some implementations, an indication of the importance (e.g., significance) of the requested information is also included in the request message, such as a different (e.g., separate) information element relative to other QoS descriptions for sensing. The indication of importance, for example, indicates a priority of the network for responding positively to the requested service. A UE, for instance, may include in the request message a priority identifier and/or class for different types of requests.
   Security/privacy: In some implementations, a sensing operation is requested to accompany measures for protecting the sensing information, such as information pertaining to signal propagation and/or reflection from an object and/or area of interest that may be used by an unauthorized third-party. A type of the security measure may be included in the request message, such as for object of interest sensing information protection, area of interest sensing information protection, requesting-UE identity protection together with a specified level of security, e.g., as an integer number defining a specified security level.

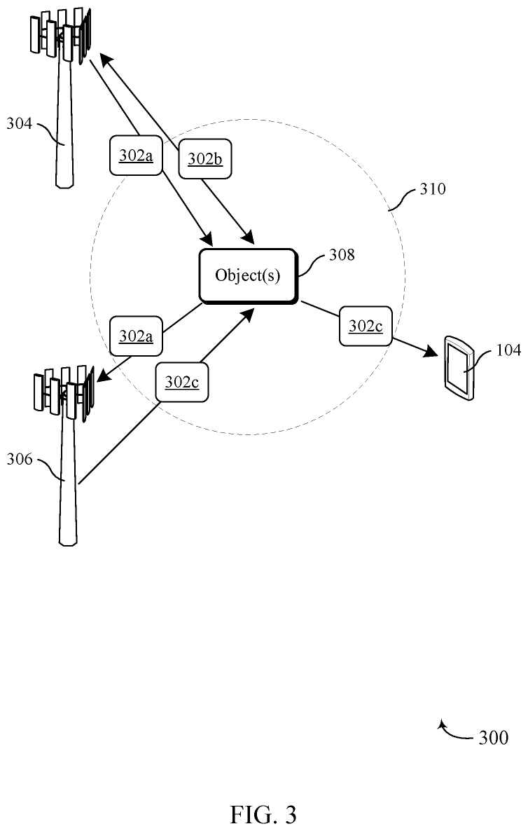

FIG. 3 illustrates example scenarios 300 for radio sensing that supports configuration for radio sensing in accordance with aspects of the present disclosure. The scenarios 300 include:

Scenario 302a with a sensing Tx as a network node 304 and sensing Rx as a separate network node 306, which represent different instances of network entities 102: In the scenario 302a, the sensing reference signal (and/or another reference signal used for sensing or data and/or control channels known to the network TRP nodes) is transmitted and received by network entities 102. The involvement of UE nodes can be limited such as to aspects of interference management. The network may not utilize UEs for sensing assistance in the scenario 302a.

Scenario 302b with a sensing Tx as the network node 304 and sensing Rx as the same network node 304: In the scenario 302b, the sensing reference signal (and/or another reference signal used for sensing or the data and/or control channels known to the network TRP nodes) is transmitted and received by the same network entity 102. The involvement of UE nodes can be limited such as to aspects of interference management. The network may not utilize UEs for sensing assistance in the scenario 302b.

Scenario 302c with a sensing Tx as the network node 306 and a sensing Rx as a UE 104: In the scenario 302c, the sensing reference signal or other reference signal used for sensing is transmitted by a network entity 102 and received by one or multiple UEs 104. A network, for instance, configures the UE(s) 104 to act as a sensing Rx node, such as according to the UE nodes capabilities for sensing and/or a specified sensing task.

As part of the scenarios 302a-302c, the radio sensing is implementing to detect feature characteristics of objects 308 present in an environment 310.

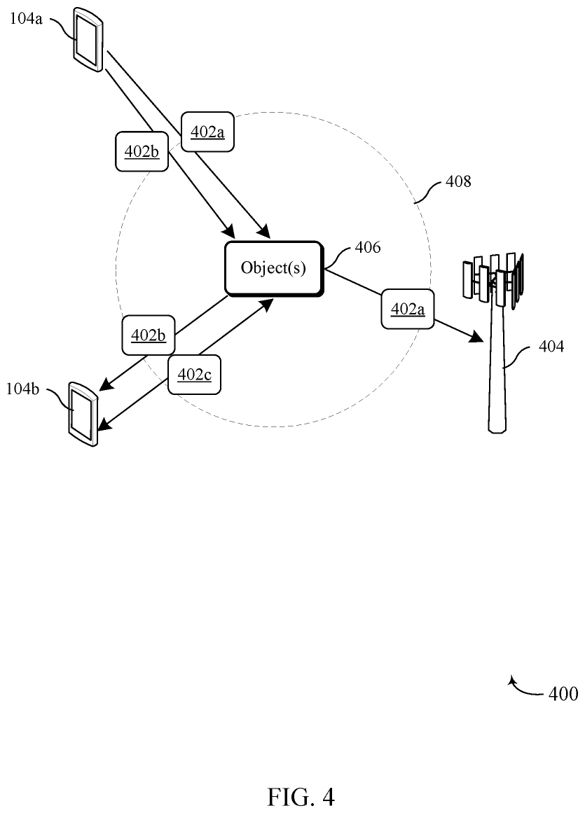

FIG. 4 illustrates example scenarios 400 for radio sensing that supports configuration for radio sensing in accordance with aspects of the present disclosure. The scenarios 300, 400, for example, represent additional and/or alternative implementations. The scenarios 400 include:

Scenario 402a with a sensing Tx as a UE 104a and sensing Rx as a network node 404: In the scenario 402a, the sensing reference signal or other reference signal used for sensing (and/or a data and/or control channel transmitted by the UE 104a) is received by one or multiple network entities 102 (e.g., the network node 404) and transmitted by the UE 104a. A network, for instance, configures the UE 104a to act as a sensing Tx node, such as according to the UE 104a capabilities for sensing and/or a specified sensing task.

Scenario 402b with a sensing Tx as the UE 104a and a sensing Rx as a separate UE 104b: In the scenario 402b, the sensing reference signal or other reference signal used for sensing is received by one or multiple UEs 104b and transmitted by the UE 104a. In this scenario, the network and/or a UE 104 may decide on configuration of the sensing scenario. In at least one example, a network configures the UEs 104 to act as a sensing Tx and/or sensing Rx nodes, such as according to the UE 104 capabilities for sensing and/or a specified sensing task.

Scenario 402c with a sensing Tx as the UE 104b and sensing Rx as the same UE 104b: In the scenario 402c, the sensing reference signal (and/or another reference signal used for sensing and/or the data and/or control channels known to the UE) is transmitted by the UE 104b and received by the same UE 104b. In at least one implementation, the UE 104b and/or a network configures the sensing scenario, such as according to the UE 104 capabilities for sensing and/or a specified sensing task.

As part of the scenarios 402a-402c, the radio sensing is implementing to detect feature characteristics of objects 406 present in an environment 408. Further, the different scenarios 302, 402 are presented for purpose of example only, and it is to be appreciated that implementations for configuration for radio sensing can be employed in a variety of different scenarios including scenarios not expressly described herein.

In at least some implementations, sensing Rx configurations are provided that include known (e.g., a priori known) feature characteristics of objects that can be sensed via radio sensing. For instance, a radio sensing controller entity (e.g., a network entity 102) configures a sensing Rx node with one or multiple of:
(1) A first configuration regarding the transmission of a sensing reference signal by a sensing Tx node to be received and processed by the sensing Rx node;
(2) A second configuration for an expected receiver signal processing and/or measurements of the received sensing reference signal as part of a radio sensing operation, based on, among other considerations, the known characteristics of an object of interest and/or a respective radio sensing scenario; and
(3) A third configuration for the transmission of a report from the performed sensing processing, such as according to the first and second configurations.

The sensing Rx node can then perform the reception of the sensing reference signal and perform respective radio sensing measurement and/or processing according to the received first and second configurations, and subsequently may generate and transmit a report according to the received third configuration.

In at least some implementations, the radio sensing controller entity may be implemented as and/or operate as part of a third-party application on a UE device, a RAN node (e.g., a gNB, a smart repeater, a IAB node, a UE/gNB-roadside unit (RSU), etc.), as part of a core network entity, e.g., a radio sensing management function, etc. Further to at least some implementations, a set of sensing Rx nodes associated with a radio sensing scenario may include UE devices, network entities (e.g., gNB nodes), UE/gNB-RSU nodes, smart repeaters, IAB nodes, smart repeater node, and/or combinations thereof.

The first configuration such as introduced above for the transmitted sensing reference signal by a sensing Tx node to be received by the sensing Rx node may include at least one or multiple of:
a) A waveform type or waveform-defining parameters for the sensing reference signal signal, e.g., the waveform type in case the waveform is different from that of the used waveform for other data/control transmission/receptions by the same nodes, subcarrier spacing (SCS) for the sensing reference signal signal in case of OFDM-based waveforms or other multi-carrier waveform types, the length and type of redundancy, e.g., CP-length in case of CP-OFDM, or redundancy type and length in case of unique word (UW)-OFDM;
b) The location of the sensing Tx (the sensing reference signal transmitting entity) according to a global or local/relative or known coordinate system by the sensing Rx, or a relative location of the sensing Tx with respect to the object/area of interest to radio sensing;
c) One or multiple Tx antenna port or transmission beams or transmission radiation pattern or transmission radiation characteristics (e.g., panning angle, beam angle in azimuth, beam angle in elevation/zenith, beam width) for the transmission of the sensing reference signal;
d) Sensing reference signal resources according to the used waveform for sensing reference signal transmission, e.g., CP-OFDM time/frequency resources over which the sensing reference signal is transmitted;
e) Tx power for the transmission of the sensing reference signal;
f) Sequence generation and physical-resource-mapping type based on which sensing reference signal is generated.

The second configuration such as introduced above for the receiver signal processing and/or measurements of the received sensing reference signal may include one or more of:
a) Indication of one or more Rx spatial filters to be used by the sensing Rx for the reception of the sensing reference signal;
b) Indication of one or multiple features of an object and/or scenario of interest for sensing according to which sensing measurements and/or signal processing is to be implemented;
c) One or multiple types of processing and/or computation results to be generated from the received sensing reference signal, the received configurations.

Further, the second configuration such as introduced above for the receiver signal processing and/or measurements of the received sensing reference signal may be determined (e.g., by a radio sensing controller) based on one or more of:
a) A priori known characteristics of an object or objects of interest, such as related to a specified radio sensing operation;
b) A radio sensing-related capability of a sensing Rx node, e.g., including but not limited to:
   i. Stationarity (e.g., position stability) of the sensing Rx for a specified sensing duration;
   ii. One or more of time, frequency, angular, or location synchronization level of the sensing Rx with the sensing Tx node(s);
   iii. Observability region of the sensing Rx with respect to the object and/or area of interest.
c) Radio sensing-related capability of other participating sensing Rx nodes in the sensing scenario;
d) Availability of one or more of time, frequency, energy, storage resources, or processing resources for the radio sensing operation among the available radio sensing nodes;
e) Specified quality-of-service for a specified radio sensing task.

In at least some implementations, a priori known features of an object and/or scenario of interest for sensing according to which sensing measurements and/or signal processing is to be implemented may include one or more of:
a) Expected object presence probability;
b) A probability mass function of the number of existing objects within the related sensing area of interest;
c) A location, a location range, set, and/or potential area of an object of interest (if present) according to a coordinate system such as a global, local, relative, and/or known coordinate system to a sensing Rx node;
d) A probability mass function of an object position conditioned on the object being present, e.g., 0.2 probability of object occurrence over a cube identified by (5,5,5)<(x,y,z)< (15,15,15) in 3D; 0.2 probability of occurrence within a 2D rectangular area (5,5)< (x,y)<(15,15); 0.2 probability of occurrence over a 1D area representation 5<x<15; and/or 0.2 probability of occurrence over an angular region representation (e.g., azimuth and/or elevation/zenith angle range) according to a coordinate system such as a global, local, relative, and/or known coordinate system to a sensing Rx node;
e) A velocity and/or a velocity set and/or range, such as including an absolute velocity range and/or possible directions of movement, e.g., direction or angular range of movement with respect to a coordinate system such as a global, local, relative, and/or known coordinate system of an object of interest conditioned on the object being present;
f) A probability mass function of the object velocity (absolute velocity, velocity direction, and/or or directional velocity, e.g., which can be combined) over known velocity segments, e.g., 0.2 probability of occurrence over 10-20 kilometers per hour (kmh) along the north direction with +/−10 degree deviation, 0.3 probability of occurrence over 10-20 kmh, 0.4 probability of occurrence with a movement along the north direction with +/−10 degree deviation, etc.;
g) A probability mass function of the object Doppler characteristics. e.g., Doppler range and/or spread;
h) Expected object RCS pattern and/or parameters related to a resulting RCS pattern, e.g., object size, object composite, object material, and object figure, or a probability mass function on different combinations thereof, e.g., probability mass function for different RCS pattern and/or value ranges on different object sizes or shapes;
i) One or multiple potential object types (e.g., a person, a vehicle, a cat, a dog, a building, a wall, etc.) and/or a probability mass function thereof;
j) A semantic representation of an object as a feasible state that for an object and/or a mass probability density function thereof, e.g., a possible human or animal body posture: e.g., standing, sleeping, bending, different standing postures, different hand gestures, different heart and/or breathing states, etc.;
k) Indication to a prior sensing Rx processing and/or a known object type by the sensing Rx node where the object of interest, if present, may share properties with the known or previously analyzed object by the sensing Rx node;
l) Features obtained from the combination of instances of the above features, e.g., joint probability mass function over multiple domains, e.g., power-angle-delay-doppler segments of the measured CSI.

Instances of the probability measures discussed herein may be presented as unconditional values and/or conditional probability measures, such as conditioned on an object being present.

Accordingly, solutions are provided in this disclosure to provide intelligent radio sensing including optimizing radio sensing measurements and signal processing, and reporting for radio sensing operations based on known attributes of radio sensing environments. Further, the described solutions enable features of a background environment to be considered when performing radio sensing of an environment.

In the context of a radio sensing implemented within a communication network, a sensing Rx node may acquire knowledge of the background environment related to the radio sensing, and subsequently utilize the knowledge of the background environment for the sensing Rx measurements and obtaining sensing information regarding area and/or objects of interest for sensing. Accordingly, in implementations, a radio sensing controller entity configures a sensing Rx node with one or multiple of:
a) a first configuration regarding sensing reference signal to be transmitted by a sensing Tx node, and to be received and processed by the sensing Rx node;
b) a second configuration, according to which the sensing Rx can acquire the background environment knowledge related to a radio sensing operation;
c) a third configuration for expected sensing Rx measurements and signal processing related to the radio sensing operation, which may utilize received sensing reference signal according to the first configuration, as well as the acquired background environment knowledge according to the second configuration;
d) a fourth configuration for the transmission of a report from sensing measurements and signal processing of the received signals, such as according to the configurations described above.

According to the received configurations such as described above, a sensing Rx node can:
a) receive transmitted sensing reference signal;
b) acquire background environment knowledge;
c) perform sensing Rx measurements and signal processing according to the acquired knowledge of the background environment;
d) generate and transmit a sensing measurement report to a network entity.

In implementations, a background environment includes physical features other than objects of interest to be monitored via radio sensing (e.g., sensing targes), such as other non-target objects, environment features (e.g., a portion of the ground, sea surface, etc.), propagation paths towards a sensing Rx node, e.g., a line of sight (LOS) propagation path towards a sensing Rx from a sensing Tx node, a LOS or non-LOS (NLOS) propagation path towards the sensing Rx from a sensing Tx node or an external interference transmitter, etc. In implementations, a background environment includes set of objects, environment parts, and/or propagation paths towards a sensing Rx node:
a) for which the sensing reference signal reflection and/or propagation can be perceived by the sensing Rx node, e.g., when a propagation path exists between an object reflection towards the sensing Rx node and the received sensing reference signal strength and/or power corresponding to the propagation path at the sensing Rx is above a threshold (e.g., sensing Rx receiver sensitivity) for a given sensing Tx power;
b) for which objects, environment features, and/or propagation path transmission points are located within a known distance and/or angular margin (e.g., azimuth and/or elevation) or relative velocity margin (e.g., velocity value or direction, and/or directional velocity) with respect to an object of interest for monitoring via radio sensing by the sensing Rx node;
c) which may block the reflection of the transmitted sensing reference signal from an object of interest for sensing towards the sensing Rx node;
d) for which the propagation path towards the sensing Rx may be blocked via the object of interest for sensing and/or other objects;
e) which differ from the object of interest being monitored via radio sensing in one or multiple features. Examples of the features include being located in a different area, location, and/or angular region, having a different velocity and/or velocity margin than the object of interest, remaining present and/or static over different monitoring time instances whereas the presence and/or location of the object of interest may vary for different sensing reference signal reception instances;
f) for which presence, location, velocity and/or a combination thereof of features of a background environment are known;
g) any instance and/or combination of the conditions above, e.g., constructed via one or multiple of union of, intersection of, subtraction of, the sets generated according to the above conditions.

In implementations, background environment features and/or a subset thereof are part of a set of objects of interest for monitoring, e.g., where a subset of objects of interest are reliably detected and tracked and, in a later sensing reference signal reception and/or in a later processing step, are treated as background environment objects to facilitate the detection and/or tracking of remaining objects of interest.

In implementations, a radio sensing controller entity may be implemented as and/or operate as part of a third-party application on a UE device, a RAN node (e.g., a gNB, a smart repeater, a UE/gNB-RSU, a IAB node), or operates as part of a core network entity, e.g., a radio sensing management function.

In implementations, a radio sensing controller entity performs at least one or multiple of the following functions:
a) collects capability information of radio sensing-capable nodes to act as a sensing Tx node;
b) collects capability information of radio sensing-capable nodes to act as a sensing Rx node;
c) determines a sensing scenario including at least a sensing Tx node, a sensing Rx node similar or different from the sensing Rx node, an area of interest for monitoring and/or sensing, etc.;
d) determines a configuration for at least one sensing Rx node to obtain information of the background environment;
e) configures one or multiple sensing Tx nodes with a sensing signal transmission, e.g., including configurations of the time-frequency, beam resources, the reference signal sequence for sensing reference signal, etc.;
f) configures one or multiple sensing Rx nodes with sensing signal reception, measurement, and processing;
g) configures one or multiple sensing Rx nodes with a sensing measurement reporting configuration, e.g., reporting criterion, reporting time-frequency and beam resources, reporting information type, etc.;
h) configures one or multiple sensing Rx nodes to obtain background environment knowledge;
i) performs processing of collected sensing measurements from the sensing Rx nodes and obtains specified sensing information;
j) configures one or multiple processor entities to obtain an indicated set of specified sensing information outcomes, such as based on the received sensing measurement reports of the sensing Rx nodes;
k) reports the obtained sensing information (e.g., upon reception of the sensing Rx reports and processing) to a RAN and/or network entity, such as according to a prior indication and/or configuration.

In implementations, a set of sensing Rx nodes associated with a radio sensing scenario may include UE devices, gNB nodes, UE/gNB-RSU nodes, smart repeaters, IAB nodes, or combinations thereof.

The first configuration such as introduced above for the transmitted sensing reference signal by a sensing Tx node to be received by the sensing Rx node may include at least one or multiple of:
a) A waveform type or waveform-defining parameters for the sensing reference signal, e.g., the waveform type in case the waveform is different from that of the used waveform for other data/control transmission/receptions by the same nodes, subcarrier spacing (SCS) for the sensing reference signal signal in case of OFDM-based waveforms or other multi-carrier waveform types, the length and type of redundancy, e.g., CP-length in case of CP-OFDM, or redundancy type and length in case of unique word (UW)-OFDM;
b) The location of the sensing Tx (the sensing reference signal transmitting entity) according to a global or local/relative or known coordinate system by the sensing Rx, or a relative location of the sensing Tx with respect to the object/area of interest to radio sensing;
c) One or multiple Tx antenna port or transmission beams or transmission radiation pattern or transmission radiation characteristics (e.g., panning angle, beam angle in azimuth, beam angle in elevation/zenith, beam width) for the transmission of the sensing reference signal;
d) Sensing reference signal resources according to the used waveform for sensing reference signal transmission, e.g., CP-OFDM time/frequency resources over which the sensing reference signal is transmitted;
e) Tx power for the transmission of the sensing reference signal;
f) Sequence generation and physical-resource-mapping type based on which sensing reference signal is generated.

The configuration described above for the acquisition of the relevant background environment knowledge by the sensing Rx node may include the indication of explicit background environment information, a configuration for acquisition of the background environment information elements explicitly from another network node, and/or a configuration for implicitly acquiring the background environment knowledge via the assistance and/or processing of the received signals by the sensing Rx according to the received configuration, and/or combinations thereof.

An explicit transfer and/or indication of background information elements to the sensing Rx node may include an indication of one or more of:
a) an object identifier (ID), a group object ID, and/or multiple IDs thereof, where each object ID may define an a priori known object with all or a subset of known features, e.g., objects with a known position, velocity, orientation, type, composite, etc.;
b) one or multiple object positions according to a global and/or known (e.g., local, relative) coordinate system;
c) one or multiple object velocities according to a global and/or known coordinate system;
d) one or multiple object RCS patterns according to a global and/or known coordinate system, an average RCS value, and/or an average RCS pattern as an average over the RCS pattern over a certain direction and/or angle;
e) one or multiple object physical and/or geometrical shapes;
f) one or multiple object types, such as classified to known types by the sensing Rx node, e.g., vehicle, human, etc.;
g) one or multiple object orientations;
h) one or multiple object composite and/or texture types;
i) a 2D or 3D map of the background environment as perceived by the sensing Rx node, and/or according to a global and/or known coordinate system to the sensing Rx node, e.g., a partial point cloud and/or bitmap describing a subset of environment objects, subset of features of the environment objects, or a combination thereof.
j) CSI presented in a specific domain and/or via a metric known to the sensing Rx node corresponding to a complete or a portion of the background environment from a known sensing Tx towards the sensing Rx node, e.g., a power delay profile of the sensing Tx to sensing Rx CSI corresponding to the background environment within n meters distance from the sensing Rx.
k) compressed and/or quantized values of any of the above information types. For instance, the value of any or multiple of the above information, separately or jointly, are presented via one or multiple indices from a table and/or codebook, where the table/codebook defines different possible values for the above information types or a combination thereof, e.g., a table of the object velocity values. For instance, the 2D or 3D map is compressed with a known format and/or resolution at the sensing Rx side, presented via a 2D or 3D bitmap image or a compressed bitmap image, where each bit represents presence of an object at a specific location;
l) statistical measure of any of the above elements. For instance, a probability mass function of position, doppler spread or doppler shift, and/or delay spread or average delay of a part of the background defined by a specific angular and/or doppler range to the sensing Rx node;
m) one or multiple sets of time, frequency, and/or beam resources to receive one or a combination of the above information types from one or multiple other network nodes. For instance, a UE device acting as sensing Rx node receives part of a 3D map of the static environment as part of a downlink (DL) physical channel from a gNB and another part of the 3D map of the static environment from another UE from a sidelink (SL) channel, where the corresponding time-frequency-beam resources to receive the information can be included in the received second configuration;
n) a combination of one or multiple of the above.

In implementations an implicit indication of background environment information elements to the sensing Rx node may include:
a) indication or configuration (e.g., including all or a subset of the elements defined within the received first configuration described above for the reception of the sensing reference signal) of one or multiple sensing reference signal receptions other than the sensing reference signal reception configured via the first configuration described above by the sensing Rx node, where the background information knowledge and/or the information of the objects of interest/sensing target nodes (e.g., to be separated from the background environment effects) can be inferred from the one or multiple of the sensing reference signal receptions. In implementations, the one or multiple sensing reference signal receptions can be used jointly with the sensing reference signal reception configured via the received first configuration described above in order to obtain and/or extract information on the background environment or the objects of interest;
b) indication of a state (e.g., position, presence, velocity, blockage, etc.) of background environment elements and/or how they are related or are similar among the sensing reference signal reception configured via the first configuration described above and received by the sensing Rx node and other sensing reference signal receptions indicated via the implicit indication of the background environment information. This may include one or multiple of:
   i. an indication that the objects constituting the background environment effects hold similar properties during all or a subset of the indicated sensing reference signal receptions;
   ii. a statistical measure indication that the objects constituting the background environment effects hold approximately similar known properties during multiple sensing reference signal receptions: For instance, when the statistics of the background environment features remain approximately consistent, including doppler shift and average delay experienced due to the background environment reflections, e.g., 95 percent of the background environment objects remain with approximately consistent known properties during different sensing reference signal receptions;
   iii. a conditional indication that the objects constituting the background environment effects hold similar or approximately similar known properties during the indicated multiple sensing reference signal receptions: For instance, when 95% of objects of the background environment located within a specific location or velocity range according to a known coordinated system to the sensing Rx node hold the approximately similar known properties during the indicated multiple sensing reference signal receptions;
   iv. combinations thereof, e.g., conditional and statistical indications of the similarity of the sensing reference signal reception phases.
c) indication of a state (e.g., position, presence, velocity) of the objects of interest for sensing (i.e., sensing target objects) and/or how they are related or remain similar among the sensing reference signal reception configured via the first configuration received by the sensing Rx node and other sensing reference signal receptions indicated via the implicit indication of the background environment information. This may include one or multiple of:
   i. indication that all or a subset of the object/objects of interest are not present at an indicated set of sensing reference signal receptions;
   ii. indication that all or a subset of the object/objects of interest are present at an indicated set of sensing reference signal receptions and hold a similar property and/or state, e.g., position, velocity, etc.;
   iii. indication that all or a subset of the object/objects of interest are present at an indicated set of sensing reference signal receptions and hold an approximately similar property and/or state, e.g., position and/or velocity within 95% relative accuracy to a reference sensing reference signal reception instant.
d) indication of a sensing measurement configuration, including sensing reference signal transmission configurations. Examples of sensing reference signal transmission configuration include a transmission antenna port, Tx power, beam and/or radiation pattern, transmission radiation characteristics (e.g., panning angle, beam angle in azimuth, beam angle in elevation/zenith, beam width), a sensing Tx location, sensing Tx node velocity or a relative velocity of the sensing Tx to the sensing Rx node, or combinations thereof. Further, sensing measurement configuration can include sensing reference signal reception configurations and/or indication of how the sensing reference signal transmission and/or reception configurations are related or remain approximately similar over multiple sensing reference signal receptions configured via the first configuration described above and received by the sensing Rx node and/or other sensing reference signal receptions indicated via the implicit indication of the background environment information. The indication of how the sensing reference signal transmission and/or reception configurations are related or remain approximately similar over the multiple sensing reference signal receptions may include one or multiple of:
   i. indication that all or a subset of elements of sensing measurement setup remain constant and/or approximately similar over an indicated set of the sensing reference signal receptions;
   ii. indication that all or a subset of the elements of sensing measurement setup (e.g., a transmission power, beam or radiation pattern, the sensing Tx location, or a subset thereof) remain constant and/or approximately similar over an indicated set of the sensing reference signal receptions;
   iii. indication that all or a subset of the elements of sensing measurement setup used over an indicated set of sensing reference signal reception (e.g., a transmission power, beam or radiation pattern, the sensing Tx location, or a subset thereof) will not be valid for another indicated set of the sensing reference signal receptions;
   iv. indication that all or a subset of the elements of sensing measurement setup (e.g., a transmission power, beam or radiation pattern, the sensing Tx location, or a subset thereof) remain approximately constant over an indicated set of the sensing reference signal receptions, e.g., with a 95% probability or within a 90% energy margin of the incident wave reflection from the same area.

In implementations, instances of the above information elements associated with a sensing reference signal reception instance may be indicated together with the configuration of the same sensing reference signal instance. In implementations, a subset of the information elements associated with a specific sensing reference signal reception instance are indicated to the sensing Rx node or any other processing node subsequently to the sensing reference signal being received by the sensing Rx node, e.g., at a later time, a later frame/subframe, a later configuration instance, etc. This may include:
a) indication to the sensing Rx node at a later time that a previous sensing determination/result from a sensing Rx report is correct or incorrect, is within a known margin of accuracy (e.g., a detected object was actually present and/or an estimated range or position is correct or within a 10 cm margin or within a 1 index different from a used codebook for estimated parameter indication), or a correction by which the correct sensing information of a previous erroneous sensing result can be obtained at the sensing Rx;
b) indication to the sensing Rx node regarding the state of one or multiple of the objects of interest at a prior instance of sensing reference signal reception by the sensing Rx node, as determined by the network or other nodes, including, e.g., the presence of one or multiple objects, their positions or velocity.

In implementations, the subsequent indication on the state of the object can be given via an a priori indication, e.g., an indication that such subsequent indication may be given after a maximum of a known time duration (e.g., 10 msec or 3 durations of sensing reference signal) from the current sensing reference signal reception instance, and thereby the sensing Rx can be indicated to store the related configuration and received sensing reference signal to enable the future processing and/or measurements.

In implementations, a subset of the information elements associated with a specific sensing reference signal reception instance can be indicated to the sensing Rx node or any other processing node in advance of receiving the reference signal, including:
a) a joint configuration of multiple sensing reference signal reception periods for the sensing Rx node, indicating all or a subset of the defined measurement setup similarity information elements;
b) indication defining one or multiple of the similarity information elements that may persist over all or a subset of indicated configurations of the sensing reference signal, unless otherwise is indicated: For instance, the sensing Tx location remains the same over forthcoming sensing reference signal configurations. For instance, the indicated background environment statistics remains the same over forthcoming sensing reference signal configurations, unless a change is indicated.

In implementations, combinations of the multiple above information elements, defined within the explicit and/or implicit background environment information transfer, jointly define the background environment information elements for the sensing Rx node. For instance, via an explicit transfer and/or indication of the background environment information, a sensing Rx node receives a low-resolution 2D map of the background environment, the doppler spread of the objects associated with the background environment, and separately receives the information defining the set of object location and types from a configured time-frequency resource within a physical DL channel. The information on the background environment can then be aggregated to the a priori known background environment information from the previous sensing reference signal receptions, according to a received implicit indication of the background environment information.

In implementations, the above information elements for implicit or explicit indication of the background environment information and/or the information on the similarity of the measurement setups over multiple sensing reference signal receptions can be defined conditionally, e.g., assuming an indicated and/or predefined domain and/or margin (e.g., a known 3D or 2D area), a known angular (azimuth or elevation) margin, a known velocity margin, a known velocity directional margin, over which the indicated information element is valid and/or over which an indicated parameter value is measured and/or interpreted. In implementations, an indication that the Tx beam and/or radiation pattern is equal between two sensing reference signal receptions is only valid for an elevation angle of [0-45] degrees. In another implementation, the indicated 3D map of the environment is valid only over an area of 10 square meters with sensing Tx node as the center.

In implementations, any of the above information elements for implicit or explicit indication of the background environment information, or the information on the similarity of the measurement setups over multiple sensing reference signal receptions, can be defined adaptively and/or relatively to the previous indications of information elements. In implementations, a partial 2D or 3D map of the environment is transferred when the information on an indicated portion of the environment is to be updated and/or additional information is transferred to update and/or change the 3D map. As such, the sensing Rx node can continue to assume validity of previous information until and unless such information update is indicated. In implementations, for all, a subset or any of the described information elements for implicit or explicit indication of the background environment information, or the information on the similarity of the measurement setups over multiple sensing reference signal receptions, a validity time duration can be indicated where the indicated information is assumed to be valid, unless explicitly modified via a separate indication or when a validity time duration is expired.

The third configuration described above for the expected receiver signal processing and/or measurements of received sensing reference signal can include:
a) indication of one or more Rx spatial filters to be used by the sensing Rx for the reception of a sensing reference signal;
b) one or multiple information types of processing and/or computation outcomes to be generated from sensing measurements;
c) one or multiple sensing quality of service and/or key performance indications (KPIs) (e.g., accuracy, error probability, outage probability, latency) to be considered for the indicated information output types;
d) one or multiple conditions and/or criteria according to which some of the measurement output information types and/or the sensing quality of service are to be determined according to the outcome of other sensing measurement output and/or information types;
e) Combinations thereof.

In implementations, measurement information output can be generated based on one or multiple of:
a) received sensing reference signal according to the received first configuration described above;
b) received sensing reference signal instances according to the received second configuration and the configuration on the implicit information of the sensing reference signal described above;
c) received information on the background environment knowledge, according to the received second configuration described above;
d) a priori known features of the object/objects of interest for sensing.

In implementations, measurement and signal processing steps for the generation of the sensing outcome can be obtained based on the type of the sensing information outcome, the specified quality of service, available time, storage, and/or computation resources, radio frequency (RF) capabilities, etc.

In implementations, the measurement information output types may include one or multiple of:
a) a detected and/or estimated feature of the object or objects of interest for sensing, and/or a quantized or probabilistic representation thereof;
b) a blockage event on one or multiple objects or group of (e.g., closely located) objects or known propagation paths of the background environment and/or specified objects of interest;
c) a modification of a state of an instance of the background environment objects, or objects of interest, or a group of (e.g., closely located) objects thereof. The modification may include: a change in position, a change in velocity, a change in the perceived RCS, blockage of a background reflection path or a LOS path, a common change and/or blockage among the group of objects, etc.

In implementations, the fourth configuration described above for the transmission of a report from the performed sensing processing may include:
a) a set of time and/or frequency and beam resources for the transmission of a report;
b) one or multiple criteria for the transmission of the report, e.g., a time pattern for sensing reporting, or criterion based on the generated processing outcomes. This can include one or multiple of:
   i. when a measurement information, according to a measurement information output type is available;
   ii. when a generated measurement information output according to a measurement information output type, or multiple of the generated measurement outputs satisfy a condition. Examples of the condition include a measured received reference signal power is above a threshold, when an object is detected with a reported probability of higher than an indicated probability (e.g., 95%), when a modification of an a priori known object (or group of objects) state persists over a specific period, when an object is detected with a threshold probability at an indicated sensitive area of monitoring, and/or when one or multiple objects are detected to moving towards an area of sensitivity.
c) a type of the information to be included in a report may include all or a subset of the indicated processing and/or computation outcomes.

In implementations, the type of the information included in the report and the period and/or criteria according to which a specific report is to be activated for one or multiple sensing reference signal reception instances can be inter-related and may be defined jointly or separately. For instance, the sensing Rx node may receive one or multiple reporting configurations for different criteria and/or reporting types corresponding to one or multiple sensing reference signal processing instances.

In implementations, the resources, the type of the information included in the report, and the period or criteria according to which a specific report is to be activated are jointly or separately related to the type of the measurement output types indicated via the third configuration described above. For instance, in some implementations, some of the described elements may be defined jointly, e.g., when the indicated measurement output types via the third configuration, upon availability, are to be reported according to the configuration of the time and/or frequency resources for reporting transmission.

In implementations, any of the described configurations (e.g., the first, second, third and fourth configurations and the measurement report or a subset thereof) are communicated between the sensing Rx and the network or sensing controller entity via the uplink (UL), DL, and/or SL physical data and/or control channels defined within the communication network, e.g., NR physical broadcast channel (PBCH), physical downlink shared channel (PDSCH), physical downlink control channel (PDCCH), physical uplink shared channel (PUSCH), physical uplink control channel (PUCCH), physical sidelink broadcast channel (PSBCH), physical sidelink control channel (PSCCH), physical sidelink shared channel (PSSCH), etc., In implementations, one or multiple of the configurations or part of information elements thereof is communicated via RRC and/or higher layer signaling.

In implementations, one or multiple of the configurations and/or part of information elements thereof are communicated between the network and the sensing Rx node via a sensing Rx specific or group-common downlink control information (DCI) and/or a broadcast or a multicast message. In implementations, different configurations and/or different information elements within one configuration is communicated via different signaling means (e.g., the resources for sensing reference signal and/or the information elements containing the explicit or implicit background environment information) may be indicated via the RRC or higher layer signaling. Further, the activation of a sensing operation and type of the processing outcome may be defined dynamically via the DCI, e.g., on the PDCCH, a sensing Rx specific or group common DCI, a MAC-control element (CE), etc. In implementations, one or more portions of the configurations described herein or a subset of the information elements therein may be communicated to the sensing Rx node via a NAS message between a core network function. In implementations, a sensing Rx report may be communicated to a core network entity via a NAS message.

Implementations described herein also enable environment-knowledge assisted clutter removal via sensing Rx processing. For instance, an effect of a background environment includes a clutter effect that may impact the sensing Rx observation of the objects of interest for sensing. Thus, the clutter effect can be estimated and/or constructed at the sensing Rx and subtracted from the received sensing reference signal, and/or filtered out and/or separated from the received sensing reference signal at the sensing Rx. The sensing Rx measurement and generation of the sensing results (e.g., according to the received third configuration described above) can then be performed utilizing the signal after the subtraction and/or filtering operation(s).

In implementations, the estimation of the background environment clutter effect and subsequently subtraction of the obtained estimate from the received sensing reference signal can be performed after transformation of the sensing reference signal to a desired domain. For instance, the estimate of the background environment effect can also be generated at the domain to facilitate the subtraction. The filtered and/or subtracted signal in the domain can then be utilized to perform further measurements and/or processing and generate the sensing measurement outcomes, such as according to the received third configuration described above. In implementations, the domain is a channel power delay profile for a delay range of [1-10] nanoseconds (ns) experienced according to a known time-reference at the sensing Rx node. The impact of the background environment can be constructed and subtracted from the estimated power delay profile of the overall channel within the [1-10] ns margin.

In implementations, the domain may further include a measured CSI value as one or more of a power delay profile, delay doppler profile, angular (azimuth/elevation) power delay profile, doppler angular power delay profile, or combinations thereof.

In implementations, the filtering out of the background environment effect includes the transformation of the received sensing reference signal into a specified domain and reduction and/or elimination of the obtained CSI components within a specific range in the specified domain. In implementations, the filtering out of static and/or distant clutter effects includes measurement of CSI values based on the received sensing reference signal at the sensing Rx node in the delay doppler domain and removing the components with doppler frequency of smaller than 10 Hz and/or delay of more than 20 ns from the measured CSI within the delay doppler domain.

In implementations, the clutter reduction process includes a combination of one or multiple of filtering out of the clutter effect in a first value range of the first transformed domain, as well as the subtraction of estimated clutter effects in a second domain. In an implementation, a first step of the clutter reduction process includes the filtering out of the static and/or distant clutter effects including measurement of the CSI values based on the received sensing reference signal at the sensing Rx node in the delay doppler domain and removing the components with doppler frequency of smaller than 10 Hz and/or delay of more than 20 ns from the measured CSI within the delay doppler domain. Further, in a second step, the process includes estimating and removing the impact of a closely located and known moving object with a known velocity (as part of the background environment), by subtracting the estimated CSI components corresponding to the object from the remaining CSI after the subtraction in the first step in the delay doppler CSI domain.

In implementations, the specified domain includes a condition according to which the reference signal reception, filtering out, measurements, clutter and background environment effect estimation and subtraction, is performed. The condition may include, for example, a location range, angular range (e.g., [20-80] degree of elevation), doppler range, power range, and combinations thereof.

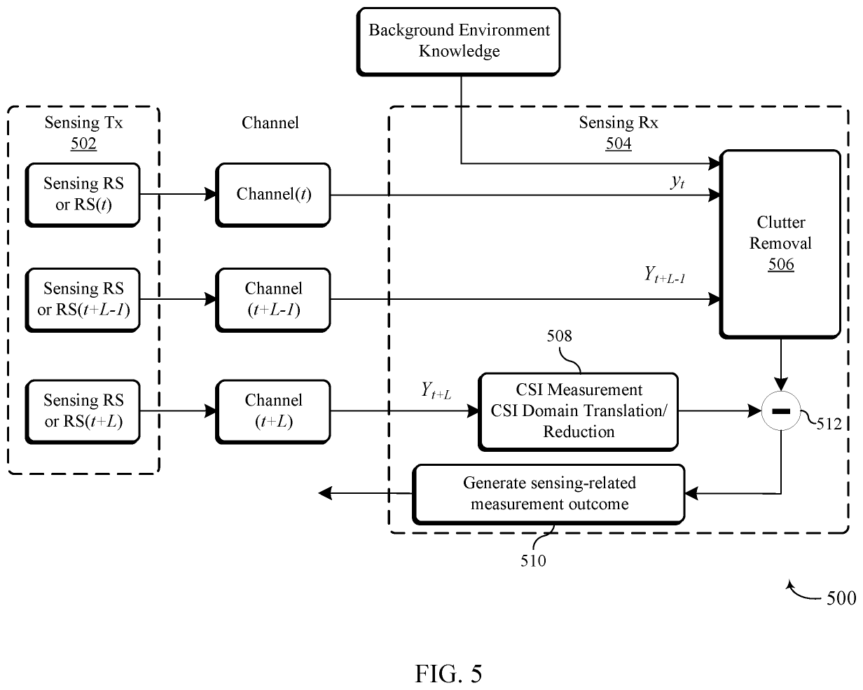

FIG. 5 illustrates a system 500 for radio sensing that supports configuration for radio sensing in accordance with aspects of the present disclosure. The system 500, for instance, represents an example schematic of a clutter effect removal process. The system 500 includes a sensing Tx node 502 and a sensing Rx node 504 and the sensing Rx node 504 is depicted as utilizing background environment knowledge for clutter removal. Further, the sensing Rx node 504 receives different sensing reference signals (“Sensing RS”) from the sensing Tx node 502 over different channels and performs clutter removal processing 506 on the sensing reference signal. According to implementations at 508 CSI processing is performed on at least some of the received reference signal. Further, at 510 sensing measurements are generated based at least in part on the clutter removal 506.

In implementations the background environment effect, including the clutter effect, is obtained via an explicit information exchange from another node (e.g., a sensing controller function or another node according to the received configuration), via processing of the previously sent sensing reference signal from the sensing Tx node 502, or a combination thereof, and subtracted at 512 from the sensing reference signal measurement values in a configured domain. The depicted CSI domain measurements and domain reduction steps may or may not be implemented (e.g., when no CSI measurement is done prior to subtraction) and are determined either via an indication from the network controller entity according to the nature of the sensing operation and the sensing Rx node 504 and other sensing Rx node capabilities or are determined autonomously by the sensing Rx node 504 according to the received configuration and the available time/memory/computational resources. In the system 500, the indices (t), . . . (t+L) indicate the time instances at which the sensing reference signal is transmitted by the sensing Tx node 502.

In implementations, the processing associated with the estimation of the background environment effect (e.g., processing prior to the subtraction), as well as the post-subtraction processing/measurements can be done adaptively. For instance, when new information is received (e.g., a new sensing reference signal or a new segment of the sensing reference signal (e.g., each symbol or resource block belonging to the sensing reference signal) or new information on the background environment (e.g., a new part of the 2D or 3D map)), a value of the pre-subtraction and post-subtraction measurements can be updated accordingly. In implementations, parameters assisting the determination of the adaptive processing strategy at the sensing Rx node are indicated from the network, e.g., a time duration over which a sensing reference signal input remains in the sensing Rx processing steps.

In implementations, all or any subset of the elements for implementing the clutter removal steps, including the subtraction domain and the associated condition/range, filtering domain and the associated condition/range, are indicated by the sensing controller entity or determined locally utilizing the received configurations as well as the locally available information at the sensing Rx node. Locally available information, for instance, includes sensing Rx location, sensing Tx location, statistical data and/or history of the measured parameters, a specified sensing quality-of-service (e.g., latency, accuracy) and real-time capability of the sensing Rx node for performing a sensing task, or combinations thereof.

Implementations described herein also enable a relative state of a sensing measurement setup for a first sensing reference signal transmission configuration to be indicated via one or multiple sensing excitation relationships with respect to a second sensing reference signal transmission configuration. For instance, an excitation relationship for sensing is defined with respect to two reference signal transmissions and a particular object or object set or area of interest for radio sensing via the first and second reference signal transmissions.

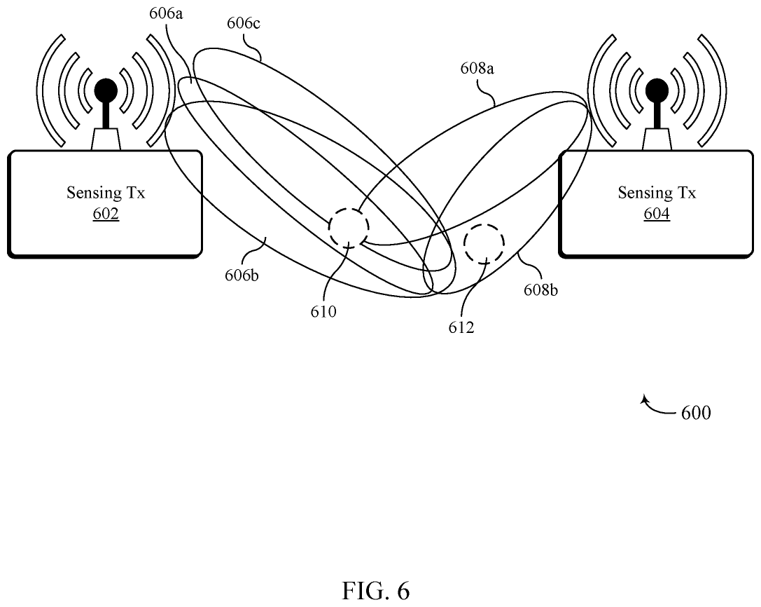

FIG. 6 illustrates a system 600 for radio sensing that supports configuration for radio sensing in accordance with aspects of the present disclosure. The system 600 includes a sensing Tx node 602 and a sensing Tx node 604. The sensing Tx node 602 transmits a reference signal 606a, an reference signal 606b, and an reference signal 606c. Further, the sensing Tx node 604 transmits a reference signal 608a and an reference signal 606b. Further, the system 600 includes an area of interest 610 (e.g., a first object of interest) and an area of interest 612, e.g., a second object of interest.

Accordingly, in the system 600, a relationship of the reference signal transmission configurations with respect to the reference signal 606a is depicted. The reference signal 606b shares the same azimuth incidence angle with the reference signal 606a transmission, but differs in the elevation angle, and spreads the incidence energy with less focus towards the area of interest 610, which may lead to a higher background environment reflections. The reference signal 606c shares the same elevation incidence angle with the reference signal 606a transmission but covers only a fraction (e.g., 80 percent) of the area of interest 610 for sensing due to the tilted beam pattern. The reference signal 608a covers the area of interest for sensing, but with a different azimuth and elevation angle compared to the sensing Tx node 602. The reference signal 608b is associated with the area of interest 612 but not associated with the first area of interest 610.

In implementations, the excitation relationship between two reference signal for a sensing scenario can be defined according to one or multiple of:
a. an object which is illuminated by first reference signal, e.g., an excitation relationship indicates that a second reference signal also illuminates the object similarly to the first reference signal;
b. azimuth angle of an incident wave from a sensing Tx towards the object of interest for sensing;
c. elevation angle of an incident wave from the sensing Tx towards the object of interest for sensing;
d. a portion of a radiation and/or beam energy and/or the radiation and/or beam energy injected to the object of interest for sensing. For instance, the same portion of the radiated energy (energy focus) or higher is illuminated towards the area of interest.
e. a portion of the radiation and/or beam energy injected to the related background environment for a sensing scenario;
f. a portion of the object of interest for sensing which is illuminated by the reference signal transmission. For instance, an excitation relations indicate that a second beam illuminates at least 90% of the object of interest;
g. a portion of the related background environment of interest for sensing which is illuminated by the reference signal transmission;
h. quasi co-located (QCL) type-D relation between the second and the first reference signal transmission.

In implementations, one or multiple excitation relationships are jointly indicated for a sensing excitation signal in relation to one or more reference signal transmissions, e.g., a first QCL type-D to a first reference signal and second excitation relationship to the first reference signal and a third excitation relationship to a second reference signal.

In implementations, the defined excitation relationships are approximate. In some implementations, an approximation accuracy level is indicated in addition to the excitation relationship indication to inform the sensing Rx node of the accuracy of the indicated excitation relationship, e.g., 95 percent of the measurement value and/or with probability of 95%.

In implementations, the defined excitation relationships are augmented with additional informative parameters, e.g., the main beam angle, or one or multiple sidelobe angles, 3 dB beamwidth for one or multiple of the sidelobes or the main beam, or combinations thereof.

In implementations, the excitation relationship may be indicated to define the reference signal transmission configuration for the sensing Rx node for a particular radio sensing scenario such as: The indecent wave towards the object of interest of a second reference signal transmission shares the same azimuth angle, elevation angle, and total or normalized energy distribution across the object of interest as the first reference signal transmission, and shares the same azimuth angle, elevation angle, and total or normalized energy distribution, across the elements of the background environment as the first reference signal transmission.

In implementations, additional excitation relationships are valid when only a subset of the relationships hold, e.g., the indecent wave towards the object of interest of a second reference signal transmission shares the same azimuth angle, and normalized energy distribution across the object of interest as the first reference signal transmission.

In implementations the indication of one or multiple excitation relationships are accompanied with a validity period after which the excitation relationship may not be valid, e.g., 2 milliseconds validity period for an indicated excitation relationship. In implementations, indication of an excitation relationship is done via an index from a table and/or codebook, where the codebook includes excitation relationships, including combinations of the above excitation relationship implementations.

Implementations described herein additionally provide for configuration of a first CSI measurement to include indication or configuration of a second CSI measurement and/or an a priori known CSI, where the first CSI measurement is performed in relation to the second CSI measurement and/or the a priori known CSI. In implementations, the CSI measurements are accompanied with a permissibility condition, such as where measurements are performed on part of a channel where the condition holds, e.g., an reference signal is received within a known margin of delay from the sensing Tx node to the sensing Rx.

In implementations, CSI measurements based on a same transmitter node at different time instances, different frequency bands, different Rx filers or angular (azimuth/elevation) range of arrival, and/or at different doppler range, may constitute the first and second CSI measurements. In implementations, a CSI measurement based on different transmitter antenna ports, different transmitter beams, and/or different transmitter nodes may constitute the first and second CSI measurements. In implementations, the a priori known CSI and/or a compressed version thereof is explicitly indicated to the sensing Rx node via the sensing controller, the sensing Tx node, or another RAN node.

In implementations, a relative measurement includes an operation between measured values, such as according to the received configurations. In implementations, the operation may include subtraction of CSI measurement values, division of the CSI measurement values, summation of the CSI measurement values, joint quantization and/or compression of the CSI measurement values, or combinations thereof. In implementations, the CSI measurement includes the measurement of the received signal strength indicator (RSSI), reference signal received power (RSRP), reference signal reception quality (RSRQ), rank indicator (RI), channel impulse response, channel profile and/or response measured across the one or multiple of doppler delay azimuth elevation domains, or combinations thereof.

In implementations, the configuration of a relative CSI measurement includes indication of a stage at which the operation, e.g., subtraction, is to be implemented. In implementations, the stage may be the signal reception stage (e.g., the raw received signal and prior to CSI measurement). In one such implementation, the relative measurement includes the subtraction of the received sensing reference signal from the second CSI measurement from the received reference signal from the first CSI measurement and measuring the received RSRP (a measurement type) from the subtracted signal, within the azimuth angular range of (e.g., [0, 30]) degrees, e.g., a permissibility condition for CSI measurement.

In implementations, the stage at which an operation is to be performed may be the target CSI measurement stage, e.g., a final measurement stage which is the same as the final measurement type/metric, where the operation (e.g., subtraction) includes the operation on (e.g., subtraction of) the resulting CSI measurement values. In one such implementation, the relative measurement includes the subtraction of measured RSRP value within the Tx-Rx delay range of ns, e.g., [1-3] ns, obtained from the first and second measurements.

In implementations, the stage at which an operation is to be performed may be an intermediate CSI measurement stage, where the CSI value after the operation can then be used to generate the intended measurement in the target CSI domain. In one such implementation, the relative measurement includes the subtraction of measured CSI components in the doppler delay domain, within the doppler range of [0-30] Hz and delay range of [1-10] ns from an indicated (e.g., known) CSI value in the similar domain, and subsequently calculation of the RSRP, RSRQ and RI as target CSI measurement values from the subtracted values in the intermediate CSI domain.

In implementations, the type of the intended relative CSI measurement, including the indication of the stage, the type of the operation, and the permissibility condition, or a combination thereof, can be indicated via one or multiple indices from one or multiple tables/codebooks, where the tables/codebook includes possible combinations of the stage, the operation, and the permissibility conditions.

In implementations, indication of the third configuration for the expected receiver signal processing/measurements of the received sensing reference signal includes an indication of a measurement threshold value for the determination of a sensing outcome. In implementations, the threshold is jointly indicated with a measurement type, measurement domain, or a combination thereof. In at least one implementation, an energy threshold is indicated for determination of an object presence to be measured over an indicated time/frequency resources and an indicated angular range. In at least some implementations, the threshold is to be applied on an indicated relative CSI measurement, e.g., measurement within a permissible domain of the remaining energy after subtraction/clutter removal.

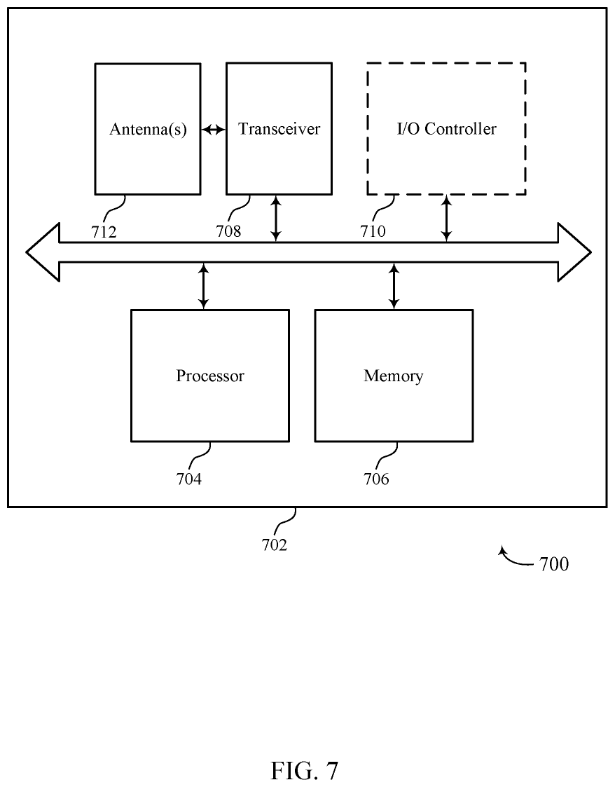

FIG. 7 illustrates an example of a block diagram 700 of a device 702 (e.g., an apparatus) that supports [title] in accordance with aspects of the present disclosure. The device 702 may be an example of UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of UE 104, for example, the transceiver 708 and the processor coupled 704 coupled to the transceiver 708 are configured to cause the UE 104 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as and/or otherwise support a means to receive a first indication including reference signal configuration, a second indication including acquisition information for background environment attributes, and a third indication including measurement configuration for radio sensing measurement; and perform, based on the received first, second and third indications, one or more of to: receive one or more reference signals; obtain background environment attributes based at least in part on the one or more reference signals and the second indication; or generate one or more radio sensing measurements based at least in part on one or more of the reference signal configuration from the first indication, the obtained background environment attributes, the second indication, or the measurement configuration from the third indication.

Further, in some implementations, the measurement configuration includes information for generating the one or more radio sensing measurements based at least in part on the background environment attributes; the processor is configured to receive the one or more reference signals based on the first indication from at least one of: an apparatus that transmits one or more of the first indication, the second indication, or the third indication; or a different apparatus than an apparatus that transmits one or more of the first indication, the second indication, or the third indication; the reference signal configuration includes at least one of: one or more of a waveform type or a set of waveform-defining parameters according to a waveform via which the one or more reference signals are transmitted; a set of resources over which the one or more reference signals are transmitted according to the waveform; one or more of a transmit beam or a radiation pattern over which the one or more reference signals are transmitted; a transmit power according to which the one or more reference signals are transmitted; one or more of a sequence type or a physical-resource-mapping type based on which the one or more reference signals are generated; or a location of a transmit node from which the one or more reference signals are transmitted.

Further, in some implementations, the set of resources over which the one or more reference signals are transmitted include one or more time-frequency resources for a CP-OFDM waveform; the acquisition information for background environment attributes includes at least one of: a resource set including at least one of a set of time resources, a set of frequency resources, or a set of beam resources for reception of the background environment attributes; or one or more types of the background environment attributes embedded within the said resource set, where the one or more types of the background environment attributes include at least one of one or more data types or one or more format types; the one or more types of the background environment attributes include at least one of: one or more of an object identifier or a group object identifier; one or more object features including at least one of an object position, an object velocity, an object radar cross section pattern, an object shape, an object type, an object orientation, an object composite, or an object texture; a map of a background environment; one or more channel state information (CSI) measurements including at least a portion of a background environment effect and an indication of a CSI measurement type; one or more of compressed values or quantized values for the background environment attributes; or one or more statistical measures of background environment attributes.

Further, in some implementations, the acquisition information for background environment attributes includes at least one of: one or more second configurations defining one or more reference signals other than the received one or more reference signals received from a second apparatus according to the reference signal configuration of the first indication; one or more third configurations defining one or more reference signals received from a third apparatus; or a subset of time-frequency resources defined within the reference signal configuration received with the first indication; the one or more second configurations and the one or more third configurations include one or more of a set of time resources, a set of frequency resources, a set of beam resources, a transmit beam, a radiation pattern, a waveform, a transmit location, or a transmit power; the acquisition information for background environment attributes includes state information including at least one of: an indication of one or more states of one or more objects within the background environment; or an indication of one or more states of one or more target objects.

Further, in some implementations, the acquisition information for background environment attributes includes one or more of: indication of one or more reference signal receptions for which the state information is valid; or a time pattern (e.g., an initial time and a time duration and/or a time pattern within one or multiple indicated reference signals) for which the state information is valid (e.g., for which reference signal reception in the background environment is blocked, during which time and/or reference signal reception the object of interest is not present); the processor is further configured to receive the state information subsequent to the one or more reference signals; the processor is further configured to receive a fourth indication including: an instruction to perform one or more of quantization or compression on at least one of the one or more reference signals or the one or more radio sensing measurements to generate one or more of quantized values or compressed values; and an instruction to store one or more of the quantized values, the compressed values, or the one or more radio sensing measurements, and the time pattern for which the state information is valid; the processor is further configured to receive the state information prior to the one or more reference signals.

Further, in some implementations, the first indication including reference signal configuration includes an excitation relationship for radio sensing with respect to a known reference signal configuration; the excitation relationship for radio sensing is based on at least one of: illumination of an area of interest; an azimuth angle of an incident wave towards one or more of an area or object of interest for sensing; an elevation angle of an incident wave towards one or more of an area or object of interest for sensing; a portion of one or more of radiation or beam energy incited to one or more of an area or object of interest for sensing; a portion of one or more of radiation or beam energy incited to a background environment for a sensing scenario; a portion of one or more of an area or object of interest for sensing which is illuminated by the one or more reference signals; or a portion of a background environment of interest for sensing which is illuminated by the one or more reference signals.

Further, in some implementations, the third indication including measurement configuration for radio sensing measurement includes at least one of: an indication of one or more spatial filters to be used for reception of the one or more reference signals; one or more sensing information outcomes to be generated from the radio sensing measurements and the background environment attributes; one or more of sensing quality of service or key performance indicators to be considered for information output of the one or more radio sensing measurements; one or more conditions according to which a first radio sensing measurement is to be performed when a second radio sensing measurement result occurs (e.g., a condition on the outcome a radio sensing measurement based on which other sensing measurements and/or measurement outcomes are indicated/requested, e.g., when an object is detected with X probability, then perform object positioning); or one or more conditions on a quality of an information output of a first radio sensing measurement when a second radio sensing measurement result occurs (e.g., a condition on the outcome of a radio sensing measurement based on which the quality of other sensing measurements and/or measurement outcomes are indicated/requested, e.g., when object is detected in a specific area, then perform positioning with a higher accuracy. For instance, if an object is present within a specific sensitive area, a positioning error is to be smaller than 0.1 meters, and otherwise smaller than 1 meters with a confidence of 99%); the at least some types of the information output include at least one of: one or more of quantized or compressed received one or more reference signals; one or more channel state information (CSI) measurements obtained from the one or more received reference signals; one or more of deterministic or statistical inference of a presence of an object of interest; one or more of deterministic or statistical knowledge of a location of an object of interest; one or more of deterministic or statistical knowledge of a velocity of an object of interest; one or more of deterministic or statistical knowledge of a RCS of an object of interest; or one or more of deterministic or statistical knowledge of at least one of a type, shape, composite, or posture of an object of interest.

Further, in some implementations, the measurement configuration for radio sensing measurement is based at least in part on: an indication of a first CSI measurement for a first reference signal relative to one or multiple of: a second CSI measurement for a second reference signal; or one or more indicated CSI measurement values; the indication of the first CSI measurement relative to the second CSI measurement includes one or more of: a first CSI measurement type; an operation type; or an operation stage; the CSI measurement type includes measurements according to at least one of: delay domain (e.g., components of the CSI (e.g., received sensing RS power, CSI matrix or a transformation thereof) for different delay values, all delay values, or a set of delay values, according to a known/shared time-reference between the sensing Tx and the sensing Rx nodes); angular-azimuth domain (e.g., components of the CSI (e.g., received sensing RS power, CSI matrix or a transformation thereof) for different values, all values, or a set of values, of azimuth angle of arrival, according to a global or local or known coordinate system; one or more of angular-elevation or zenith domain (e.g., components of the CSI (e.g., received sensing RS power, CSI matrix or a transformation thereof) for different values, all values, or a set of values, of elevation/zenith angle of arrival, according to a global or local or known coordinate system; doppler domain (e.g., components of the CSI (e.g., received sensing RS power, CSI matrix or a transformation thereof) for different values, all values, or a set of values of doppler shift, utilizing a known frequency reference for the sensing Rx node); power domain (e.g., RSRQ, RSSI, RSRP); rank measurement (e.g., RI); quantized values of CSI measurements; compressed values of CSI measurements; or summation of CSI measurements.

Further, in some implementations, the operation stage includes at least one of: a signal reception stage (e.g., wherein the received reference signals according to the configured two or more reference signals are quantized and/or stored and/or synchronized (e.g., with respect to a known time and/or frequency reference to the first device) and are utilized for an indicated operation); a CSI measurement type similar to the first CSI measurement type; or a second CSI measurement type different than the first CSI measurement type; the operation type includes at least one of: subtraction of CSI measurement values; filtering out of the first CSI measurement according to a non-zero presence of the second CSI measurement (e.g., not considering CSI values in a delay doppler domain of a first CSI measurement for which a second CSI measurement holds values above an indicated threshold); division of the first CSI measurement and the second CSI measurement; summation of the first CSI measurement and the second CSI measurement; one or more of stacking or aggregation of the first CSI measurement and the second CSI measurement (e.g., obtaining measurement on a larger angular range by augmenting a CSI measurement from a first angular segment and second CSI measurement from a second angular segment); or one or more of joint quantization or compression of the first CSI measurement and the second CSI measurement (e.g., via vector quantization of stacked values).

Further, in some implementations, the processor is further configured to: receive a fourth indication including a configuration for transmitting a sensing measurement report based at least in part on the one or more radio sensing measurements; and transmit the sensing measurement report based at least in part on the fourth indication; the fourth indication includes at least one of: a set of time, frequency, and beam resources for transmission of the sensing measurement report; a criterion for the transmission of the sensing measurement report; or type of information to include in the sensing measurement report; the third indication including measurement configuration for radio sensing measurement includes one or more sensing information outcomes to be generated from the radio sensing measurements and the background environment attributes, and where the one or more sensing information outcomes include a modification of a feature of one or more of an object of interest or a background environmental element, e.g., modification of a position, shape, orientation, presence, and/or a blockage event. The various details discussed in this section with reference to the device 702 may also apply to the device 802 described below. Further, the processor 704 of the device 702, such as a UE 104, may support wireless communication in accordance with examples as disclosed herein. The processor 704 includes at least one controller coupled with at least one memory, and is configured to or operable to cause the processor to perform various operations described herein including at least the operations described above with reference to the device 702.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M08. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

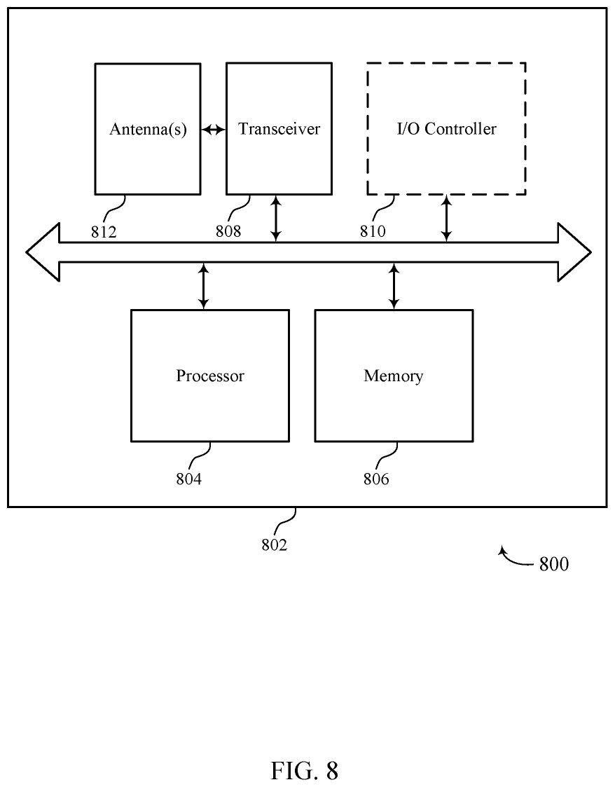

FIG. 8 illustrates an example of a block diagram 800 of a device 802 (e.g., an apparatus) that supports [title] in accordance with aspects of the present disclosure. The device 802 may be an example of network entity 102 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806). In the context of UE 104, for example, the transceiver 808 and the processor coupled 804 coupled to the transceiver 808 are configured to cause the UE 104 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as and/or otherwise support a means to receive one or more indications including one or more of: a first indication including reference signal configuration; a second indication including acquisition information for background environment attributes; a third indication including measurement configuration for radio sensing measurement; a fourth indication including configuration for reception of a sensing measurement report; a fifth indication including configuration for processing of obtained sensing measurements; or a sixth indication including a configuration for generating and transmitting a report; and perform, based on the one or more received indications, one or more of to: receive one or more radio sensing measurements; obtain background environment attributes based on at least in part on one or more of the received sensing measurements or the received second indication; perform processing on the received radio sensing measurement based at least in part on one or more of the received sensing measurements, the received fifth indication, or obtained background attributes; or generate and transmit a report, where the report is generated at least in part based on the performed processing of the received sensing measurements and is transmitted based on at least partially on the received sixth indication.

In implementations pertaining to the fifth indication discussed above such as according to the received configurations at sensing Rx nodes, the sensing Rx nodes receive the sensing reference signal and can measure the received energy at a delay-angular region corresponding to the area of interest for sensing, according to a global or a locally known coordinate system to the sensing Rx nodes. The sensing Rx nodes can transmit a report to a processor node according to the received reporting configuration. The processor node can obtain the received measurement reports, obtain a background attribute (e.g., the expected total energy, based on previous measurement and/or indication of another aware node, when the sensing target is not present at the area of interest for sensing) and determine if the target object is present at the area of interest for sensing. In this example, the sensing Rx nodes may or may not obtain and/or utilize the background environment features. Attributes may be done only at the processor node, or jointly at the sensing Rx nodes and the processor nodes.

In a further example, the processor 804 and/or the transceiver 808 may support wireless communication at the device 802 in accordance with examples as disclosed herein. For instance, the processor 804 and/or the transceiver 808 may be configured as and/or otherwise support a means to transmit, to a second apparatus, a first indication including reference signal configuration; transmit, to the second apparatus, a second indication including acquisition information for background environment attributes; transmit, to the second apparatus, a third indication including measurement configuration for radio sensing measurement; and receive, from the second apparatus, a measurement report including radio sensing measurements configured based at least in part on one or more of the reference signal configuration, the acquisition information for background environment attributes, or the measurement configuration for radio sensing measurement.

In a further example, the processor 804 and/or the transceiver 808 may support wireless communication at the device 802 in accordance with examples as disclosed herein. For instance, the processor 804 and/or the transceiver 808 may be configured as and/or support various indications and communications described above with reference to the device 702.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor M08. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (e.g., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

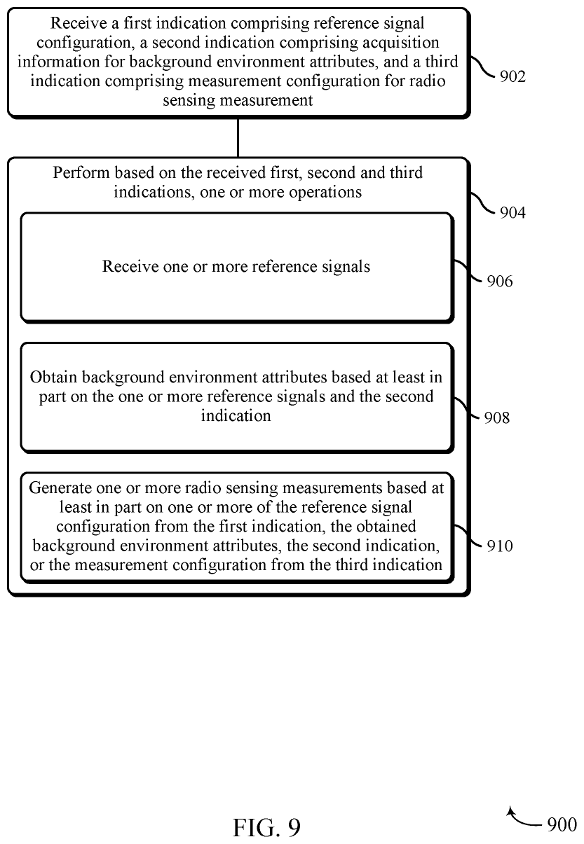

FIG. 9 illustrates a flowchart of a method 900 that supports [title] in accordance with aspects of the present disclosure. The operations of the method 900 may be implemented by a device or its components as described herein. For example, the operations of the method 900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include receiving a first indication comprising reference signal configuration, a second indication comprising acquisition information for background environment attributes, and a third indication comprising measurement configuration for radio sensing measurement. The operations of 902 may be performed in accordance with examples as described herein. In some implementations, aspects of the operations of 902 may be performed by a device as described with reference to FIG. 1.

At 904, the method may include performing, based on the received first, second and third indications, one or more operations. The operations of 904 may be performed in accordance with examples as described herein. In some implementations, aspects of the operations of 904 may be performed by a device as described with reference to FIG. 1.

At 906, the method may include receiving one or more reference signals. The operations of 906 may be performed in accordance with examples as described herein. In some implementations, aspects of the operations of 906 may be performed by a device as described with reference to FIG. 1.

At 908, the method may include obtaining background environment attributes based at least in part on the one or more reference signals and the second indication. The operations of 908 may be performed in accordance with examples as described herein. In some implementations, aspects of the operations of 908 may be performed by a device as described with reference to FIG. 1.

At 910, the method may include generating one or more radio sensing measurements based at least in part on one or more of the reference signal configuration from the first indication, the obtained background environment attributes, the second indication, or the measurement configuration from the third indication. The operations of 910 may be performed in accordance with examples as described herein. In some implementations, aspects of the operations of 910 may be performed by a device as described with reference to FIG. 1.

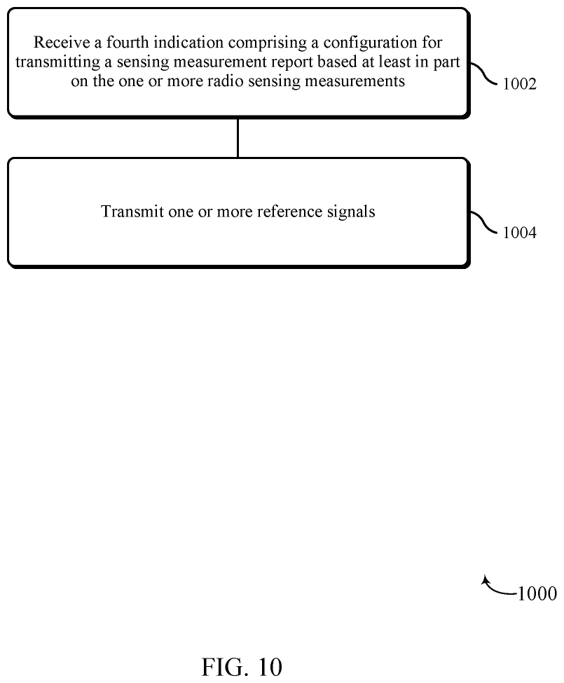

FIG. 10 illustrates a flowchart of a method 1000 that supports [title] in accordance with aspects of the present disclosure. The operations of the method 1000 may be implemented by a device or its components as described herein. For example, the operations of the method 1000 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include receiving a fourth indication comprising a configuration for transmitting a sensing measurement report based at least in part on the one or more radio sensing measurements. The operations of 1002 may be performed in accordance with examples as described herein. In some implementations, aspects of the operations of 1002 may be performed by a device as described with reference to FIG. 1.

At 1004, the method may include transmitting the sensing measurement report based at least in part on the fourth indication. The operations of 1004 may be performed in accordance with examples as described herein. In some implementations, aspects of the operations of 1004 may be performed by a device as described with reference to FIG. 1.

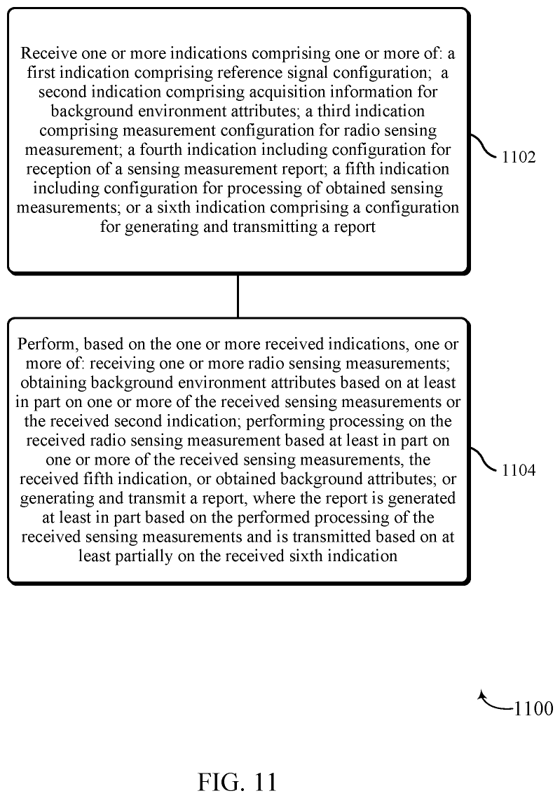

FIG. 11 illustrates a flowchart of a method 1100 that supports [title] in accordance with aspects of the present disclosure. The operations of the method 1100 may be implemented by a device or its components as described herein. For example, the operations of the method 1100 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving one or more indications comprising one or more of: a first indication comprising reference signal configuration; a second indication comprising acquisition information for background environment attributes; a third indication comprising measurement configuration for radio sensing measurement; a fourth indication including configuration for reception of a sensing measurement report; a fifth indication including configuration for processing of obtained sensing measurements; or a sixth indication comprising a configuration for generating and transmitting a report. The operations of 1102 may be performed in accordance with examples as described herein. In some implementations, aspects of the operations of 1102 may be performed by a device as described with reference to FIG. 1.

At 1104, the method may include performing, based on the one or more received indications, one or more of: receiving one or more radio sensing measurements; obtaining background environment attributes based on at least in part on one or more of the received sensing measurements or the received second indication; performing processing on the received radio sensing measurement based at least in part on one or more of the received sensing measurements, the received fifth indication, or obtained background attributes; or generating and transmit a report, where the report is generated at least in part based on the performed processing of the received sensing measurements and is transmitted based on at least partially on the received sixth indication. The operations of 1104 may be performed in accordance with examples as described herein. In some implementations, aspects of the operations of 1104 may be performed by a device as described with reference to FIG. 1.

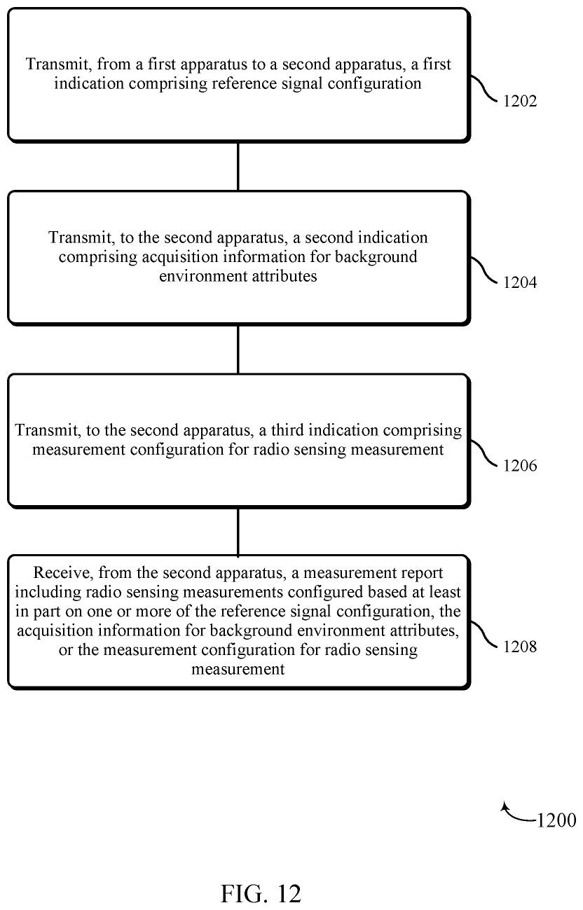

FIG. 12 illustrates a flowchart of a method 1200 that supports [title] in accordance with aspects of the present disclosure. The operations of the method 1200 may be implemented by a device or its components as described herein. For example, the operations of the method 1200 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include transmitting, from a first apparatus to a second apparatus, a first indication comprising reference signal configuration. The operations of 1202 may be performed in accordance with examples as described herein. In some implementations, aspects of the operations of 1202 may be performed by a device as described with reference to FIG. 1.

At 1204, the method may include transmitting, to the second apparatus, a second indication comprising acquisition information for background environment attributes. The operations of 1204 may be performed in accordance with examples as described herein. In some implementations, aspects of the operations of 1204 may be performed by a device as described with reference to FIG. 1.

At 1206, the method may include transmitting, to the second apparatus, a third indication comprising measurement configuration for radio sensing measurement. The operations of 1206 may be performed in accordance with examples as described herein. In some implementations, aspects of the operations of 1206 may be performed by a device as described with reference to FIG. 1.

At 1208, the method may include receiving, from the second apparatus, a measurement report including radio sensing measurements configured based at least in part on one or more of the reference signal configuration, the acquisition information for background environment attributes, or the measurement configuration for radio sensing measurement. The operations of 1208 may be performed in accordance with examples as described herein. In some implementations, aspects of the operations of 1208 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a first indication comprising reference signal configuration, a second indication comprising acquisition information for background environment attributes, and a third indication comprising measurement configuration for radio sensing measurement; and
perform, based on the received first, second and third indications, one or more of to:
receive one or more reference signals;
obtain background environment attributes based at least in part on the one or more reference signals and the second indication; or
generate one or more radio sensing measurements based at least in part on one or more of the reference signal configuration from the first indication, the obtained background environment attributes, the second indication, or the measurement configuration from the third indication.

2. The UE of claim 1, wherein the measurement configuration comprises information for generating the one or more radio sensing measurements based at least in part on the background environment attributes.

3. The UE of claim 1, wherein the at least one processor is operable to cause the UE to receive the one or more reference signals based on the first indication from at least one of:
an apparatus that transmits one or more of the first indication, the second indication, or the third indication; or
a different apparatus than an apparatus that transmits one or more of the first indication, the second indication, or the third indication.

4. The UE of claim 1, wherein the reference signal configuration comprises at least one of:
one or more of a waveform type or a set of waveform-defining parameters according to a waveform via which the one or more reference signals are transmitted;
a set of resources over which the one or more reference signals are transmitted according to the waveform;
one or more of a transmit beam or a radiation pattern over which the one or more reference signals are transmitted;
a transmit power according to which the one or more reference signals are transmitted;
one or more of a sequence type or a physical-resource-mapping type based on which the one or more reference signals are generated; or
a location of a transmit node from which the one or more reference signals are transmitted.

5. The UE of claim 4, wherein the set of resources over which the one or more reference signals are transmitted comprise one or more time-frequency resources for a cyclic-prefix orthogonal frequency-division multiplexing (CP-OFDM) waveform.

6. The UE of claim 1, wherein the acquisition information for background environment attributes comprises at least one of:
a resource set comprising at least one of a set of time resources, a set of frequency resources, or a set of beam resources for reception of the background environment attributes; or
one or more types of the background environment attributes embedded within the said resource set, wherein the one or more types of the background environment attributes comprise at least one of one or more data types or one or more format types.

7. The UE of claim 6, wherein the one or more types of the background environment attributes comprise at least one of:
one or more of an object identifier or a group object identifier;
one or more object features including at least one of an object position, an object velocity, an object radar cross section pattern, an object shape, an object type, an object orientation, an object composite, or an object texture;
a map of a background environment;
one or more channel state information (CSI) measurements comprising at least a portion of a background environment effect and an indication of a CSI measurement type;
one or more of compressed values or quantized values for the background environment attributes; or
one or more statistical measures of background environment attributes.

8. The UE of claim 1, wherein the acquisition information for background environment attributes comprises at least one of:
one or more second configurations defining one or more reference signals other than the received one or more reference signals received from a second apparatus according to the reference signal configuration of the first indication;
one or more third configurations defining one or more reference signals received from a third apparatus; or
a subset of time-frequency resources defined within the reference signal configuration received with the first indication.

9. The UE of claim 8, wherein the one or more second configurations and the one or more third configurations comprise one or more of a set of time resources, a set of frequency resources, a set of beam resources, a transmit beam, a radiation pattern, a waveform, a transmit location, or a transmit power.

10. The UE of claim 1, wherein the acquisition information for background environment attributes comprises state information comprising at least one of:
an indication of one or more states of one or more objects within the background environment; or
an indication of one or more states of one or more target objects.

11. The UE of claim 10, wherein the acquisition information for background environment attributes comprises one or more of:
indication of one or more reference signal receptions for which the state information is valid; or
a time pattern for which the state information is valid.

12. The UE of claim 11, wherein the at least one processor is operable to cause the UE to receive the state information subsequent to the one or more reference signals.

13. The UE of claim 12, wherein the at least one processor is operable to cause the UE to receive a fourth indication comprising:
an instruction to perform one or more of quantization or compression on at least one of the one or more reference signals or the one or more radio sensing measurements to generate one or more of quantized values or compressed values; and
an instruction to store one or more of the quantized values, the compressed values, or the one or more radio sensing measurements, and the time pattern for which the state information is valid.

14. The UE of claim 10, wherein the at least one processor is operable to cause the UE to receive the state information prior to the one or more reference signals.

15. The UE of claim 10, wherein the first indication comprising reference signal configuration comprises an excitation relationship for radio sensing with respect to a known reference signal configuration.

16. The UE of claim 15, wherein the excitation relationship for radio sensing is based on at least one of:
illumination of an area of interest;
an azimuth angle of an incident wave towards one or more of an area or object of interest for sensing;
an elevation angle of an incident wave towards one or more of an area or object of interest for sensing;
a portion of one or more of radiation or beam energy incited to one or more of an area or object of interest for sensing;
a portion of one or more of radiation or beam energy incited to a background environment for a sensing scenario;
a portion of one or more of an area or object of interest for sensing which is illuminated by the one or more reference signals; or
a portion of a background environment of interest for sensing which is illuminated by the one or more reference signals.

17. The UE of claim 1, wherein the third indication comprising measurement configuration for radio sensing measurement comprises at least one of:
an indication of one or more spatial filters to be used for reception of the one or more reference signals;
one or more sensing information outcomes to be generated from the one or more radio sensing measurements and the background environment attributes;
one or more of sensing quality of service or key performance indicators to be considered for information output of the one or more radio sensing measurements;
one or more conditions according to which a first radio sensing measurement is to be performed when a second radio sensing measurement result occurs; or
one or more conditions on a quality of an information output of a first radio sensing measurement when a second radio sensing measurement result occurs.

18. (canceled)

19. A network entity for wireless communication, comprising:
at least one memory; and
at least one processor coupled with the at least one memory and operable to cause the network entity to:
receive one or more indications comprising one or more of:
a first indication comprising reference signal configuration;
a second indication comprising acquisition information for background environment attributes;
a third indication comprising measurement configuration for radio sensing measurement;
a fourth indication including configuration for reception of a sensing measurement report;
a fifth indication including configuration for processing of obtained sensing measurements; or
a sixth indication comprising a configuration for generating and transmitting a report; and
perform, based on the one or more received indications, one or more of to:
receive one or more radio sensing measurements;
obtain background environment attributes based on at least in part on one or more of the one or more received radio sensing measurements or the received second indication;
perform processing on the one or more received radio sensing measurements based at least in part on one or more of the received fifth indication, or obtained background attributes; or
generate and transmit a report, wherein the report is generated at least in part based on the performed processing of the one or more received radio sensing measurements and is transmitted based on at least partially on the received sixth indication.

20. A network entity for wireless communication, comprising:
at least one memory; and
at least one processor coupled with the at least one memory and operable to cause the network entity to:
transmit, to a user equipment (UE), a first indication comprising reference signal configuration;
transmit, to the UE, a second indication comprising acquisition information for background environment attributes;
transmit, to the UE, a third indication comprising measurement configuration for radio sensing measurement; and
receive, from the UE, a measurement report including radio sensing measurements configured based at least in part on one or more of the reference signal configuration, the acquisition information for background environment attributes, or the measurement configuration for radio sensing measurement.

21. A method performed by a user equipment (UE), the method comprising:
receiving a first indication comprising reference signal configuration, a second indication comprising acquisition information for background environment attributes, and a third indication comprising measurement configuration for radio sensing measurement; and
performing, based on the received first, second, and third indications, one or more of:
receiving one or more reference signals;
obtaining background environment attributes based at least in part on the one or more reference signals and the second indication; or
generating one or more radio sensing measurements based at least in part on one or more of the reference signal configuration from the first indication, the obtained background environment attributes, the second indication, or the measurement configuration from the third indication.
